(19) United States
(12) Patent Application Publication
(10) Pub. No.: US 2025/0141912 A1
(43) Pub. Date: May 1, 2025

(54) MULTI-DOMAIN VULNERABILITY ASSESSMENT SYSTEMS AND METHODS

(71) Applicant: The MITRE Corporation, McLean, VA (US)

(72) Inventors: Jamie R. HILL, Woodland Park, CO (US); Dustin R. COUNSELL, Newton, MA (US); Chris HOFFMEISTER, Annapolis, MD (US); Jonathan M. THOMAS, Lowell, MA (US); Jonas TJAHJADI, Brighton, MA (US)

(73) Assignee: The MITRE Corporation, McLean, VA (US)

(21) Appl. No.: 18/929,887

(22) Filed: Oct. 29, 2024

Related U.S. Application Data
(60) Provisional application No. 63/594,186, filed on Oct. 30, 2023.

(51) Int. Cl. H04L 9/40

(52) U.S. Cl. CPC H04L 63/1433

(57) ABSTRACT

Systems and methods are provided for multi-domain vulnerability assessment. An exemplary system includes a plurality of wireless signal detectors, wherein each of the wireless signal detectors is configured to detect wireless signals of a respective wireless signal protocol of a plurality of wireless signal protocols. The wireless signal detectors transmit the signal data to a data processor that classifies the plurality of devices based on the wireless signal data, determines one or more device vulnerabilities associated with the plurality of devices based on the classification of the plurality of devices, and determine a plurality of device risks for the plurality of devices based on the plurality of device vulnerabilities.

### CROSS REFERENCE TO RELATED APPLICATIONS

This application claims priority to U.S. Provisional Application Ser. No. 63/594,186, filed Oct. 30, 2023, the entire contents of which are incorporated herein by reference.

### FIELD

The present disclosure relates generally to systems and methods for multi-domain vulnerability assessments and more specifically to systems and methods for ingesting and analyzing wireless signal data to determine vulnerabilities and threats.

### BACKGROUND

Critical infrastructure facilities such as railways, gas pipelines, power grids, and so on are increasingly likely to be subject to targeted, multi-domain attacks. Identification of network and device vulnerabilities to determine associated risk levels is imperative to mitigation efforts. Existing systems and methods for multi-domain vulnerability assessments fail to provide an automated, user-friendly, and real-time data ingestion and analytics pipeline for analyzing multi-domain facility vulnerabilities. Existing systems and methods are constrained by manual processes, lack of standardization, poor scalability, and are often difficult for non-radio-frequency experts to use, thus leaving critical infrastructure facilities unprepared and vulnerable to such multi-domain attacks. Accordingly, there is a need for user friendly, automated systems and methods for critical infrastructure vulnerability assessments.

### SUMMARY

Described herein are systems, methods, devices, and non-transitory computer readable storage media for performing multi-domain vulnerability assessments. According to some embodiments, the systems and methods described herein provide a pipeline for automatically ingesting data (e.g., radio-frequency signals) associated with critical infrastructure facilities and providing real-time vulnerability, weakness, threat, and/or risk indicator determinations to provide users with corresponding risk mitigation recommendations sorted by risk indicator level.

The systems and methods described herein are capable of rapid, automated, minimally invasive vulnerability assessments of facilities and infrastructure that allow non-radio-frequency experts to quickly review collected data and analytics and carry out mitigation recommendations to improve facility security against multi-domain attacks. Thus, the multi-domain vulnerability assessment systems and methods described herein enable automated, real-time, vulnerability and risk indicator determination and prompt mitigation efforts for critical infrastructure facilities in jeopardy of multi-domain attacks.

According to some embodiments, an exemplary system includes a plurality of sensors, each configured to detect one or more respective wireless signal modalities (i.e., different wireless communication protocols, such as Wi-Fi, Bluetooth, Z-Wave, OT/ICS wireless protocols 802.15.4 (Thread, 6LoWPAN, ISA100.11A, SNAP, WirelessHART, Zigbee), LoRaWAN, EnOcean, and so on) emitted by a plurality of devices. The sensors can be used to collect data needed for assessing multi-domain vulnerabilities (cyber vulnerabilities, RF vulnerabilities, physical-entry vulnerabilities, and so on), weaknesses, and/or threats. In some embodiments, the wireless signal sensors can include any one or more of Wi-Fi sensors (with or without power amplifiers), Bluetooth sensors, Z-Wave sensors, 802.15.4 sensors, and Wideband radio-frequency sensors. Additional sensors (e.g., IMU/compass sensors, GPS) may provide telemetry describing the system state while sensors collect data.

According to some embodiments, the data collected by the plurality of sensors are transmitted to a data processing system (e.g., one or more electronic devices including one or more processors for processing the data), to automatically classify devices using a plurality of classification techniques based on the wireless signal data. In some embodiments, a refined device classification is determined using a combination of the classifications determined by all, or a subset of all, of the classification techniques.

In some embodiments, the system determines, based upon the device classifications, one or more vulnerabilities associated with each device. In some embodiments, the device classifications are matched to device vulnerabilities based on a database of vulnerabilities associated with respective device classifications. According to some embodiments, the system determines a device risk associated with each device based on the determined vulnerabilities associated with the respective device. In some embodiments, the system determines the device risk by automatically searching a database of device risks associated with the respective vulnerabilities and determining a composite device risk based on a combination of the device risks associated with the respective vulnerabilities.

According to some embodiments, the system additionally or alternatively determines weaknesses and threats based on the observations of wireless signal data and wireless protocols. Wireless devices and/or networks may be associated with different weaknesses or threats based on observations about their configuration, usage, or behavior with respect to their use of wireless communication protocols. In some embodiments, the system may determine a weakness or threat based upon detection device configuration, usage, or behavior within a respective wireless communication protocol. Weakness and threat detection can add an additional layer of information to the multi-domain vulnerability assessment, presenting operators with both vulnerabilities and risks associated with observed devices, but also with observed weaknesses and threats associated with those devices and/or networks.

In some embodiments, the system organizes collected data and processing according to data collection activities defined by geospatial areas of regard and time ranges. In some embodiments, the system allows users to compare data collection activities (e.g., data collection activities at different times) for the purpose of highlighting differences in observable device inventory, distribution of device observations, configuration and usage of encryption, interactions between devices, and/or logical organization of networks. In some embodiments, the system allows users to designate a data collection activity as a baseline for purposes of alerting differences (e.g., when compared to other data collection activities) or the detection of anomalies.

According to some embodiments, the system generates reports, visualizations, alerts, or other outputs associated with a multi-domain vulnerability assessment. Visualizations may include heat maps depicting, for instance, indicating regions within a geographical space associated with relatively higher or lower levels of detected wireless signal activity.

In some embodiments, the system output includes prioritized mitigation recommendations. The mitigation recommendations may be prioritized according to the severity or level of the device risk. For instance, if the system detects a high device risk, it may automatically generate an alert and emphasize information related to the device risk in the report relative to other device risks.

In some embodiments, the system may cause a user interface to display the reports, visualizations, alerts, or other outputs associated with the classified devices, respective device vulnerabilities and risks, and weaknesses and threats. In some embodiments, the interfaces are graphical user interfaces that allow users to interact with and control the reported data and analytics as well as control system devices, for instance by activating or deactivating data collection features such as active Bluetooth interrogation. In some embodiments, the system may also generate logical network graphs based on the wireless signal data to create an interactive network map of relationships and communications between devices.

An exemplary method for determining device risk for a plurality of wireless devices based on one or more determined vulnerabilities comprises: receiving, by one or more processors, wireless signal data from a plurality of devices, wherein the received wireless signal data were detected by a plurality of wireless signal sensors; classifying each of the plurality of devices based on the wireless signal data; determining one or more vulnerabilities associated with each of the plurality of devices based on the classification of each of the plurality of devices; determining at least one device risk for each of the plurality of devices based on the one or more device vulnerabilities.

In some embodiments, the method further comprises determining a composite device risk for each device of the plurality of devices based on a combination of the plurality of device risks.

In some embodiments, the method further comprises displaying an indication of the plurality of device risks.

In some embodiments, the method comprises generating a recommended mitigation for at least one of the one or more vulnerabilities. In some embodiments, the method comprises executing the recommended mitigation for at least one of the one or more vulnerabilities, wherein the recommended mitigation comprises any one or more of: patching a device, blocking a transmission from a device, deactivating a device, and reconfiguring a device. In some embodiments, the mitigation comprises segmenting off a portion of a network where vulnerable devices were identified and/or isolating portions of the network to safeguard against initial or further exploitation of an identified vulnerability.

In some embodiments, the method further comprises determining at least one weakness associated with one or more devices of the plurality of devices. In some embodiments, the method further comprises determining at least one threat associated with one or more devices of the plurality of devices. In some embodiments, the method includes determining at least one of a weakness associated with one or more devices of the plurality of devices and a threat associated with one or more devices of the plurality of devices.

In some embodiments, the method comprises generating a recommended mitigation for the weakness or the threat. In some embodiments, the method comprises: executing the recommended mitigation, wherein the recommended mitigation comprises any one or more of: patching a device, blocking a transmission from a device, deactivating a device, and reconfiguring a device. In some embodiments, the mitigation comprises segmenting off a portion of a network where weaknesses or threats were identified and/or isolating portions of the network to safeguard against initial or further exploitation of the weakness or threat.

In some embodiments, the at least one weakness comprises any one or more of: an unencrypted wireless access point, a hidden access point, a rogue access point, a rogue hotspot access point, one or more inconsistent access point vendors, an Evil Twin access point, an unencrypted ad-hoc network, an unauthorized ad-hoc network, an always-discoverable device, an unencrypted communication, weakly encrypted communications, use of compromised encryption keys, use of vendor default encryption keys, and a 2G base station.

In some embodiments, the at least one threat comprises any one or more of a data exfiltration in progress, denial of service attacks in progress, a spoofed MAC address, spoofed devices, an Evil Twin access point, and a 2G base station.

In some embodiments, the method further comprises generating a recommended mitigation for at least one of the one or more device vulnerabilities.

In some embodiments, the method further comprises displaying the recommended mitigation.

In some embodiments, each of the plurality of wireless signal sensors is configured to detect wireless signals of a respective wireless signal protocol of a plurality of wireless signal protocols.

In some embodiments, the plurality of devices are classified using at least one of: one or more passive inference techniques and one or more active interrogation techniques.

In some embodiments, the one or more passive inference techniques comprise any one or more of: a Wi-Fi probe-request frame taxonomy, a Wi-Fi beacon frame taxonomy, a Wi-Fi protected setup taxonomy, a passive Bluetooth taxonomy, OUI vendor matching, and WPS vendor/product matching, and Bluetooth Low Energy Generic Attribute Profile Blueprinting.

In some embodiments, the one or more active interrogation techniques comprise any one or more of: active Bluetooth interrogation, active Z-Wave interrogation, and active 802.15.4 interrogation.

In some embodiments, classifying the plurality of devices comprises determining any one or more of a vendor name, a product name, or a device code. Classifying the plurality of devices may additionally or alternatively include determining a product version, operating system, and/or operating system version.

In some embodiments, the device code is a common platform enumerator (CPE), and wherein determining the one or more device vulnerabilities comprises determining a device vulnerability identifier based on the device code, wherein the device vulnerability identifier comprises a common vulnerability and exposure (CVE) number.

In some embodiments, classifying the plurality of devices comprises: generating a string based on the wireless signal data; hashing the string to generate a signature associated with a device of the plurality of devices; and classifying a respective device of the plurality of devices based on the signature.

In some embodiments, classifying the plurality of devices comprises: determining a device vendor based on a MAC address associated with the plurality of wireless signals.

In some embodiments, at least one of the plurality of devices is classified based on a combination of a plurality of classification techniques.

In some embodiments, determining the plurality of device risks for the plurality of devices based on the one or more device vulnerabilities comprises comparing the one or more device vulnerabilities to a list of predetermined device risks associated with the one or more device vulnerabilities.

In some embodiments, the method further comprises displaying a graphical user interface comprising a plurality of dashboards, wherein a first dashboard comprises an indication of the number of devices associated at least one of the one or more wireless protocols.

In some embodiments, the first dashboard comprises a user configurable geospatial view, wherein the geospatial view depicts an indication of a location of the plurality of devices. In some embodiments, the geospatial view depicts heat maps weighted by a relative strength of a signal at the sensor.

In some embodiments, the first dashboard comprises an indication of one or more of vendors associated with the plurality of devices.

In some embodiments, a second dashboard comprises a list of the plurality of devices, wherein the list comprises a device identifier associated with a device of the plurality of devices, a wireless protocol associated with the device, a vendor associated with the device, and the device risk associated with the device.

In some embodiments, a third dashboard comprises an indication of one or more weaknesses and one or more threats associated with the one or more wireless devices and/or networks.

In some embodiments, the method further comprises determining a relationship between a first device and a second device of the plurality of devices based on a communication between the first device and the second device.

In some embodiments, the method further comprises generating a network map comprising a first node associated with the first device and a second node associated with the second device, wherein the network map depicts the relationship between the first device and the second device based on the communication between the first device and the second device.

In some embodiments, the method further comprises determining one or more device subcomponents associated with a device of the plurality of devices based on the wireless signal data.

In some embodiments, the method further comprises determining one or more subcomponent vulnerabilities associated with a device subcomponent of the one or more device subcomponents.

An exemplary non-transitory computer readable storage medium stores instructions for determining device risk for a plurality of wireless devices based on one or more detected vulnerabilities the instructions configured to be executed by a system, the system comprising one or more processors to cause the system to: receive, by the one or more processors, wireless signal data from a plurality of devices, wherein the received wireless signal data were detected by a plurality of wireless signal detectors; classify the plurality of devices based on the wireless signal data; determine one or more vulnerabilities associated with each of the plurality of devices based on the classification of each of the plurality of devices; determine at least one device risk for each of the plurality of devices based on the one or more device vulnerabilities.

An exemplary system for determining device risk for a plurality of wireless devices based on one or more detected vulnerabilities comprises: one or more processors storing one or more computer programs that include computer instructions, which when executed by the one or more processors, cause the system to: receive, by the one or more processors, wireless signal data from a plurality of devices wherein the received wireless signal data were detected by a plurality of wireless signal detectors; classify the plurality of devices based on the wireless signal data; determine one or more vulnerabilities associated with each of the plurality of devices based on the classification of each of the plurality of devices; determine at least one device risk for each of the plurality of devices based on the one or more device vulnerabilities.

An exemplary system for determining device risk for a plurality of wireless devices based on one or more detected vulnerabilities comprises: a plurality of wireless signal detectors, wherein each of the wireless signal detectors is configured to detect wireless signals of a respective wireless signal protocol of a plurality of wireless signal protocols, one or more processors storing one or more computer programs that include computer instructions, which when executed by the one or more processors, cause the system to: receive, by the one or more processors, wireless signal data from a plurality of devices, wherein the received wireless signal data were detected by the plurality of wireless signal detectors; classify the plurality of devices based on the wireless signal data; determine one or more vulnerabilities associated with each of the plurality of devices based on the classification of each of the plurality of devices; determine at least one device risk for each of the plurality of devices based on the one or more device vulnerabilities.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

FIG. 1 illustrates a multi-domain vulnerability assessment system, in accordance with some embodiments.

FIG. 2 illustrates an exemplary method for determining device risk for a plurality of wireless devices, in accordance with some embodiments.

FIG. 3 illustrates a first exemplary interface of a graphical user interface for displaying information and receiving user inputs associated with a multi-domain vulnerability assessment, in accordance with some embodiments.

FIG. 4 illustrates a second exemplary interface of a graphical user interface for displaying information and receiving user inputs associated with a multi-domain vulnerability assessment, in accordance with some embodiments.

FIG. 5 illustrates a third exemplary interface of a graphical user interface for displaying information and receiving user inputs associated with a multi-domain vulnerability assessment, in accordance with some embodiments.

FIG. 6 illustrates an alternative view of the exemplary interface of FIG. 5 for displaying information and receiving user inputs associated with a multi-domain vulnerability assessment, in accordance with some embodiments.

FIG. 7 illustrates a fourth exemplary interface of a graphical user interface for displaying information and receiving user inputs associated with a multi-domain vulnerability assessment, in accordance with some embodiments.

FIG. 8 illustrates a fifth exemplary interface of a graphical user interface for displaying information and receiving user inputs associated with a multi-domain vulnerability assessment, in accordance with some embodiments.

FIG. 9A illustrates an exemplary method for generating a network map based on a multi-domain vulnerability assessment, in accordance with some embodiments.

FIG. 9B illustrates an exemplary network map, in accordance with some embodiments.

FIG. 10 illustrates an exemplary computing system, in accordance with some embodiments.

FIG. 11 illustrates an exemplary method for determining a facility risk according to some embodiments.

FIG. 12 illustrates an interactive user interface that enables a user to define one or more spatial Areas of Regard (AORs) within which wireless signal data is collected and analyzed according to some embodiments.

FIG. 13 illustrates an interactive interface that enables a user to define geographically and temporally bounded campaigns according to some embodiments.

FIG. 14A illustrates aspects of an exemplary component inventory dashboard according to some embodiments.

FIG. 14B shows a pop-up window displaying CVEs associated with a particular device shown in FIG. 14A according to some embodiments.

FIG. 15A illustrates aspects of an exemplary networks dashboard according to some embodiments.

FIG. 15B illustrates a pop-up enabling a user to investigate the devices associated with a particular network according to some embodiments.

FIG. 16 illustrates aspects of an exemplary weaknesses and threats dashboard according to some embodiments.

### DETAILED DESCRIPTION

Described herein are systems, methods, devices, and non-transitory computer readable storage media for performing multi-domain vulnerability assessments. The systems and methods provided herein enable real-time assessment of facility vulnerabilities and risks based on collected radio frequency signal data. An exemplary system for multi-domain vulnerability assessments provides an end-to-end data ingestion and analysis pipeline including any combination of: a data processing system for analyzing data collected by sensors (e.g., radio-frequency sensors, cameras, etc.) to determine vulnerabilities weaknesses and/or threats associated with devices and wireless communications protocols based on the collected data, and in turn, determining device risks (e.g., risk scores) based on the respective vulnerabilities, weaknesses, and/or threats; databases for storing information associated with the collected data; and/or interactive user interfaces for generating outputs and receiving user inputs associated with the multi-domain vulnerability assessments. The system may determine overall facility risks based on vulnerabilities, weaknesses, and threats identified associated with devices, wireless protocols, and/or networks,

According to some embodiments, a plurality of sensors are provided in a portable sensor kit that allows a user to collect signal data at a respective location of interest by performing a walk-around (i.e., by carrying the sensor kit around the location to collect data in that area). The sensor kit can include a plurality of sensors, each configured to detect a respective wireless signal modality emitted by a plurality of devices (i.e., different wireless communication protocols, such as Wi-Fi, Bluetooth, Z-Wave, OT/ICS wireless protocols 802.15.4 (Thread, 6LoWPAN, ISA100.11A, SNAP, WirelessHART, Zigbee), LoRaWAN, EnOcean, MouseJack, etc.). The sensor kit may also include cameras, accelerometers, etc. for collecting additional data for assessing vulnerabilities. For instance, cameras may be used to collect data for identifying potential physical entry vulnerabilities at a respective facility. For instance, in some embodiments, a camera could collect visual data for identifying physical entry vulnerabilities (e.g. open doors or gates) or cyber physical device vulnerabilities (e.g., security cameras, electronic door locks, badge readers, etc.). This may be done through employment of object classification techniques in image and/or video data or by manual processing. Additionally, in some embodiments, collected video data that is time synchronized with other modalities could be used for later playback to provide contextual visual information alongside detected devices and vulnerabilities based on the wireless data processing pipeline.

In some embodiments, the data processing system includes one or more processors that are configured to receive data collected by the sensor kit, classify devices associated with the respective wireless signals using a plurality of classification techniques, determine vulnerabilities based on the classifications, and determine device risks (e.g., risk scores) based on the vulnerabilities. The classification techniques may include Wi-Fi Taxonomy, Bluetooth Taxonomy, IEEE Organizational Unique Identifier (OUI) Vendor Classification, and other techniques described in further detail throughout. The system may classify a device according to a single classification technique or may use a combination of multiple techniques to determine a more refined classification. In some embodiments, a refined device classification is determined using a combination of the classifications determined by all, or a subset of all, of the classification techniques. The classification may include a common platform enumerator (CPE), which can be used to determine vulnerabilities associated with the device, as described below.

According to some embodiments, the system determines one or more vulnerabilities associated with each device based upon the device classifications. In some embodiments, a vulnerability is a flaw in a software, firmware, hardware, or service component resulting from a weakness that can be exploited, causing a negative impact to the confidentiality, integrity, or availability of an impacted component or components. In some embodiments, the device classifications are matched to device vulnerabilities based on a database of vulnerabilities associated with respective device classifications. The system may identify vulnerabilities associated with the device CPE based on common vulnerability enumeration identifiers CVE IDs associated with the CPE. According to some embodiments, the system determines a device risk associated with each device based on the determined vulnerabilities associated with the respective device. In some embodiments, a device risk is an indicator of the level of risk associated with a respective device. In some embodiments, the system determines the device risk by automatically searching a database of device risks associated with the respective vulnerabilities.

According to some embodiments, the system additionally, or alternatively, determines weaknesses and threats based on observations of wireless signal data and wireless protocols. As described above, wireless devices (and/or networks) may be associated with different weaknesses or threats based on observations about their configuration, usage, or behavior, for instance, with respect to their use of wireless communication protocols. In some embodiments, a weakness is a condition in a software, firmware, hardware, or service component that, under certain circumstances, could contribute to the introduction of vulnerabilities. In some embodiments, a threat is an indicator that a device and/or network has been compromised or otherwise being used by an attacker (e.g., devices or networks that an attacker has introduced that can be used to facilitate or perform attacks). In some embodiments, the system may determine a weakness or threat based upon detection device configuration, usage, or behavior within a respective wireless communication protocol. Weakness and threat detection can add an additional layer of information to the multi-domain vulnerability assessment, presenting operators with both vulnerabilities and risks associated with specific devices, but also weaknesses and associated threats of vulnerability exploitation.

In some embodiments, the system may determine risk indicators that are based on a combination of device vulnerabilities, weaknesses, and threats. In some embodiments, a risk indicator is an indicator of a level of risk associated with a respective component/device (e.g., of a facility being assessed). Such risk indicators may provide a more comprehensive view of the risk associated with various facility components/devices.

In some embodiments, the system generates reports, visualizations, alerts, or other outputs associated with a multi-domain vulnerability assessment. In some embodiments, the system output includes prioritized risk mitigation recommendations. The mitigation recommendations may be prioritized according to the severity or level of the risk (e.g., device risk or other risk indicator). In some examples, the system may recommend prioritizing risk mitigation efforts for one facility over another based on a severity of a risk and/or a priority level of the facility. For instance, if the system detects a high device risk, it may automatically generate an alert and emphasize information related to the device risk in the report relative to other device risks. In some embodiments, the system outputs are provided on an interactive user interface. The user interfaces may be graphical user interfaces that allow users to interact with and control the reported data and analytics as well as control system components, for instance by activating or deactivating data collection features such as active Bluetooth interrogation.

In some embodiments, the system may automatically execute recommended mitigations for at least one of the one or more vulnerabilities. Recommended mitigations may include any one or more of: patching a device (e.g., pushing out a software update), blocking a transmission from a device, deactivating a device, reconfiguring a device (e.g., to enhance encryption), segmenting off a portion of a network where vulnerable devices were identified and/or isolating portions of the network to safeguard against initial or further exploitation of an identified vulnerability. The aforementioned mitigation actions may also be generated and executed by the system for identified weaknesses and/or threats. In some examples, the system recommends a mitigation, and the mitigation is executed by another system and/or an administrator, such as an IT professional. Other exemplary mitigation actions are described throughout the disclosure.

In some embodiments, the system outputs also include a logical network map. The logical network maps generated by the system may visually represent a network of devices emitting signals at or near a facility being assessed by the system that allows a user to quickly identify connections between the devices. The logical network map may depict devices and subcomponents of the respective devices (e.g., hierarchical relationships between the devices), relationships between separate devices, communications between devices, and so on. As such, provided herein is a system for multi-domain vulnerability assessment that functions as an end-to-end data ingestion and analysis platform for determining vulnerabilities, weaknesses, threats, and risk indicators, identifying and recommending mitigations measures, and displaying comprehensive analytical reports for user review in real-time.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

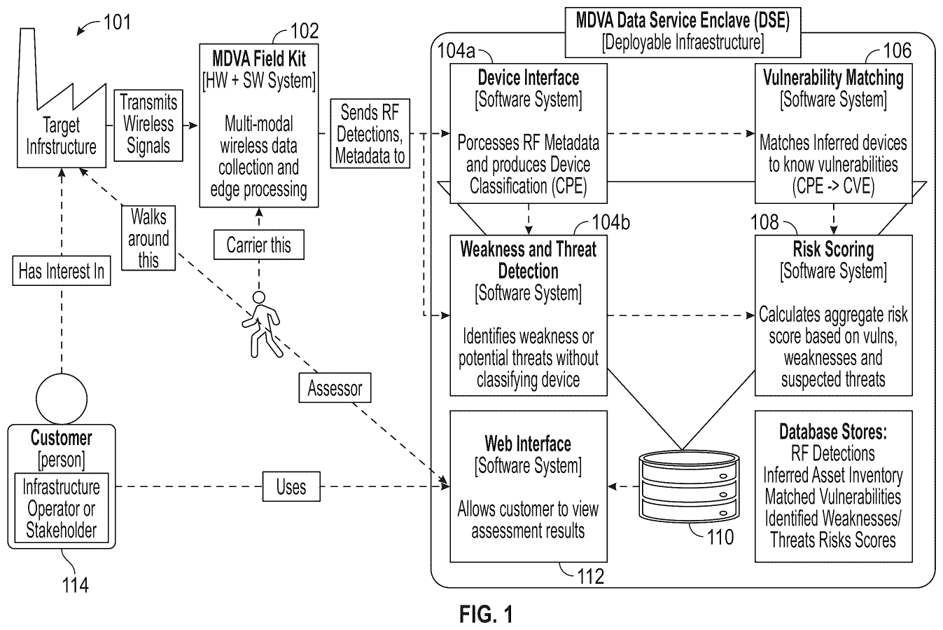

FIG. 1 illustrates an exemplary multi-domain vulnerability assessment system for performing a process 100, in accordance with some embodiments. Process 100 is performed, for example, at least partially using one or more electronic devices. While portions of process 100 are described herein as being performed by particular devices, it will be appreciated that process 100 is not so limited. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

At block 102, wireless signal data may be collected from a plurality of wireless devices by a multi-modal wireless data collection and edge processing sensor kit. In some embodiments, the plurality of wireless devices are located within or near a specific geographic location or facility, such as facility 101. In some embodiments, the wireless signal data include any one or more of Wi-Fi data, Bluetooth data, Z-Wave data, OT/ICS wireless data, 802.15.4 (Thread, 6LoWPAN, ISA100.11A, SNAP, WirelessHART, Zigbee), LoRaWAN data, EnOcean data, and Wideband radio-frequency data. In some embodiments, the wireless signal data are detected by a plurality of wireless signal sensors included in a portable multi-modal wireless data collection and edge processing kit, which may include sensor hardware and corresponding software. In some embodiments, the wireless signal sensors can include either or both of commercial-off-the-shelf (COTS) and government-off-the-shelf (GOTS) based sensors. In some embodiments, the wireless signal sensors can include any one or more of Wi-Fi sensors (with or without power amplifiers), Bluetooth sensors, Z-Wave sensors, 802.15.4 sensors, and/or Wideband radio-frequency sensors. The kit may also include IMU/compass sensors, and GPS sensors. In some embodiments, the wireless signal sensors can be configured for radio-frequency signal collection and edge processing. In some embodiments, each of the wireless signal detectors is configured to detect wireless signals of a respective wireless signal protocol of a plurality of wireless signal protocols (e.g., Bluetooth, Wi-Fi, Z-Wave, etc.).

In some embodiments, the wireless signal sensors are enclosed in a sensor housing. In some embodiments the sensor housing is a compact case that a user can hand-carry. In some embodiments a multimode antenna is external to the compact case and is connected to the wireless signal sensors and transmits detected wireless signals to the wireless signal sensors. In some embodiments, the sensor kit includes cameras, accelerometers, etc. for collecting additional data for assessing vulnerabilities, weaknesses, and threats. In some embodiments the camera is a color (RGB) camera. The camera can be used to collect images of a location being scanned by the wireless signal sensors. For instance, in some embodiments, a camera could collect visual data for identifying physical entry vulnerabilities (e.g. open doors or gates) or cyber physical device vulnerabilities (e.g., security cameras, electronic door locks, badge readers, etc.). This may be done through employment of object classification techniques in image and/or video data or by manual processing. Additionally, in some embodiments, collected video data that is time synchronized with other modalities (such as the wireless signal data) could be used for later playback to provide contextual visual information alongside detected devices and vulnerabilities based on the wireless data processing pipeline.

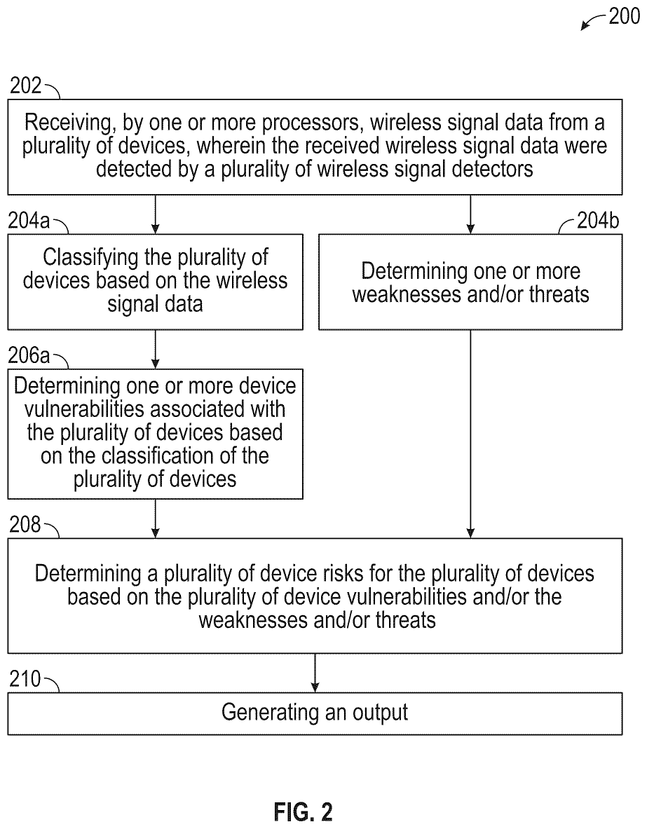

At block 104a, the system receives wireless signal data (as well as other data including image data, etc. collected by any sensors in the sensor kit) and performs device classification based on the wireless signal data collected at block 102. In some embodiments, the wireless signal sensors in the sensor kit transmit collected wireless signal data to one or more processors for device classification at block 104. The one or more processors can include computer programs that include instructions, which when executed by the one or more processors, cause the system to perform a variety of device classification techniques. The device classification techniques can include one or both of passive inference techniques and active interrogation techniques. In some embodiments, the one or more passive inference techniques include any one or more of a Wi-Fi probe-request frame taxonomy, a Wi-Fi beacon frame taxonomy, a Wi-Fi protected setup taxonomy, a Bluetooth taxonomy, and OUI Vendor classification/matching techniques. In some embodiments, Wi-Fi probe-request frame taxonomy is used to derive a plurality of Wi-Fi taxonomy signatures. In some embodiments, the Wi-Fi taxonomy signatures include any of a MAC address from a Wi-Fi frame, Wi-Fi radiofrequency band, Wi-Fi frame type, Wi-Fi taxonomy version, Wi-Fi taxonomy string, and/or Wi-Fi taxonomy shell. In some embodiments, the one or more active interrogation techniques include any one or more of active Bluetooth interrogation, active Z-Wave interrogation, active ZigBee interrogation, and/or active 802.15.4 interrogation. Further detail regarding the above classification techniques is provided below with reference to FIG. 2. In some embodiments, the device classification includes any one or more of a vendor (e.g., Apple, Samsung, etc.), a device type (e.g., Galaxy Note), a common platform enumerator (CPE), and/or an address (e.g., MAC address or IP address).

In some embodiments, the system performs device classification at block 104a using a combination of classification techniques. The system may apply a plurality of classification techniques to signals detected across different wireless signal protocols emitted by a respective device, and determine a refined classification based upon a combination of the respective classification techniques used for each wireless signal protocol. For instance, a first classification technique may indicate that device A is associated with vendor X or vendor Y. A second classification technique may indicate that device A is associated with vendor X. Combining the classifications assigned by the two respective techniques may result in a higher confidence refined classification of device A as associated with vendor X. In some embodiments, the system can transmit device classification data to an asset inventory database, at block 110, to generate inventory reports as described further below. In some embodiments, the system performs de-duplication to remove duplicate devices from consideration.

At block 104b, the system receives wireless signal data (as well as other data including image data, etc. collected by any sensors in the sensor kit) and performs weakness and threat detection. Wireless devices may be associated with different weaknesses or threats based on observations about their configuration, usage, or behavior with respect to their use of wireless communication protocols. In some embodiments, the system may determine a weakness or threat based upon detection device configuration, usage, or behavior within a respective wireless communication protocol (e.g., Wi-Fi, Bluetooth, Z-Wave, Zigbee, etc.). In some embodiments, the one or more weaknesses and/or threats include weaknesses and/or threats associated with Wi-Fi devices and protocols. Weaknesses and/or threats associated with Wi-Fi devices and protocols can include Wi-Fi access point weaknesses and/or threats and Wi-Fi client weaknesses and/or threats. Wi-Fi access point weaknesses and/or threats can include any one or more of an unencrypted access point, a weakly encrypted access point, a hidden access point, a rogue access point, a rogue hotspot access point, an Evil Twin access point, inconsistent access point vendors, an unexpected access point vendor, and access point MAC address spoofing. In some embodiments, the one or more weaknesses and/or threats associated with Bluetooth devices and protocols can include any one or more of always-discoverable devices and unencrypted serial communications. In some embodiments, the weaknesses and/or threats may be associated with ZigBee devices and protocols, Z-Wave devices and protocols, WirelessHart devices and protocols, LoRaWan devices and protocols, and 2G Cellular weaknesses and/or threats. Further description related to detection of weaknesses and/or threats is provided below with reference to FIG. 2. In some embodiments, the weaknesses and threats identified at block 104b are used to determine aggregate risk indicators at block 108, as described below. Weaknesses and/or threats may be identified at block 104b without previously classifying the device associated with the detected signal data at block 104a.

At block 106, the system may determine device vulnerabilities for each of the respective devices classified based on the wireless signal data at block 104a. In some embodiments, one or more processors are configured to match device classifications determined at block 104a to vulnerabilities to determine a device risk for each device. In some embodiments, the system determines one or more vulnerabilities associated with a respective device by matching CPEs associated with the device to a Common Vulnerabilities and Exposure identifier (CVE ID). CVE IDs are a unique, alphanumeric identifier assigned. Each CVE ID references a specific vulnerability associated with, for instance, a device or software program. In some embodiments, the system searches a database of matching CPEs and CVE IDs to determine the vulnerabilities associated with a device. In some embodiments, CPEs are matched to respective CVE IDs using a matching algorithm. In some embodiments, the system may also determine one or more device specific weaknesses based on a device classification.

At block 108, the system may determine device risks associated with respective wireless devices based on device vulnerabilities identified at block 106 and weaknesses and/or threats identified at block 104b. In some embodiments, the system can determine a plurality of device risks for each of the plurality of devices based on the plurality of device vulnerabilities, and/or weaknesses and/or threats associated with devices. In some embodiments, device risk is calculated for each device based on a number and a severity of matched CVE IDs, Known Exploited Vulnerabilities (KEVs), and detected weaknesses and/or threats.

In some embodiments, determining the plurality of device risks includes comparing the one or more device vulnerabilities to a list of predetermined device risks associated with the one or more device vulnerabilities. For instance, the system may automatically correlate a CVE ID with one or more device risks included in the National Vulnerability Database. In some embodiments, determining the plurality of device risks for the plurality of devices further includes determining a threat of exploitation of a device vulnerability. For instance, the system may automatically correlate a CPE or CVE ID with an active exploitation of the CPE or CVE ID based on an exploited vulnerability published by the Department of Homeland Security's Critical Infrastructure Security Agency. In some embodiments, determining the plurality of device risks includes matching classified devices to Common Vulnerability Scoring System (CVSS) scores. A CVSS score provides an indication of the severity of a common vulnerability enumeration (CVE). In some embodiments, the system can transmit device risk data to an asset inventory database at block 108.

At block 110, the system may generate and store an inventory of unique observable devices per wireless communication protocol/modality in a database, wherein each device in the inventory is assigned a device risk that is stored in the database. In some embodiments, wireless signal data detected at block 102 is stored in the database at block 110. In some embodiments, matched vulnerabilities as block 106 are stored in the database at block 110. In some embodiments, identified weaknesses and/or threats at block 104b are stored in the database at block 110.

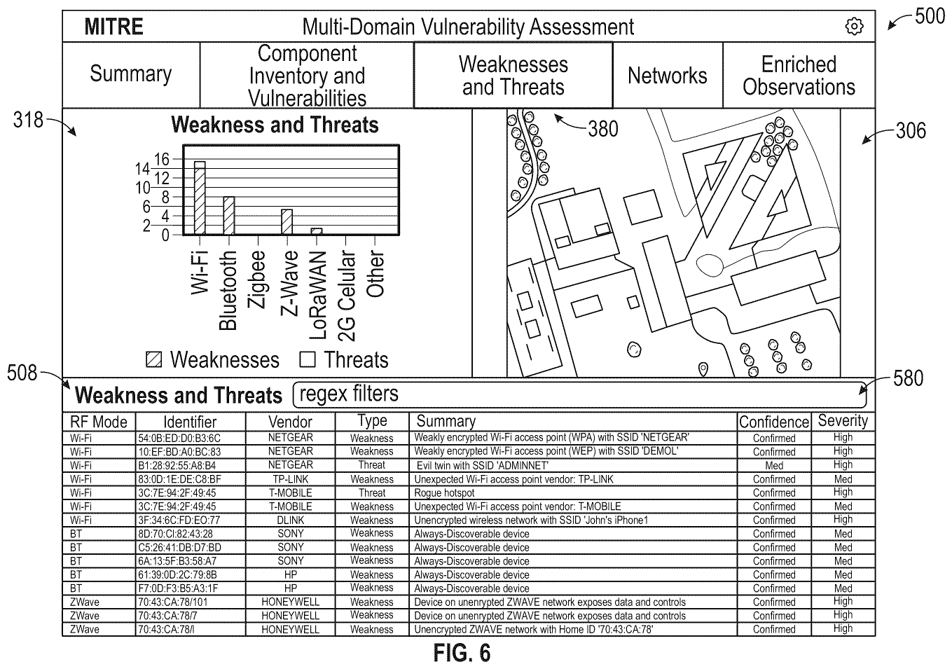

At block 110, the system may also generate outputs associated with the collected wireless signal data. For instance, the system may generate reports including device classifications, device vulnerabilities, weaknesses and/or threats, device risks, and other information associated with the collected wireless signal data. In some embodiments, the device risks, vulnerabilities, weaknesses, and/or threats are output in accordance with a determined importance or severity of the device risk (i.e., the level of risk). In some embodiments, the output includes a recommended mitigation for any one or more of the device risks, vulnerabilities, and weaknesses and/or threats. The mitigation recommendations may be prioritized according to the severity or level of the risk or vulnerability. In some embodiments, the system may also infer device relationships, including device and sub-component hierarchies and communications between devices, and generate a logical network map based on the device relationships, as described further below with reference to FIG. 6.

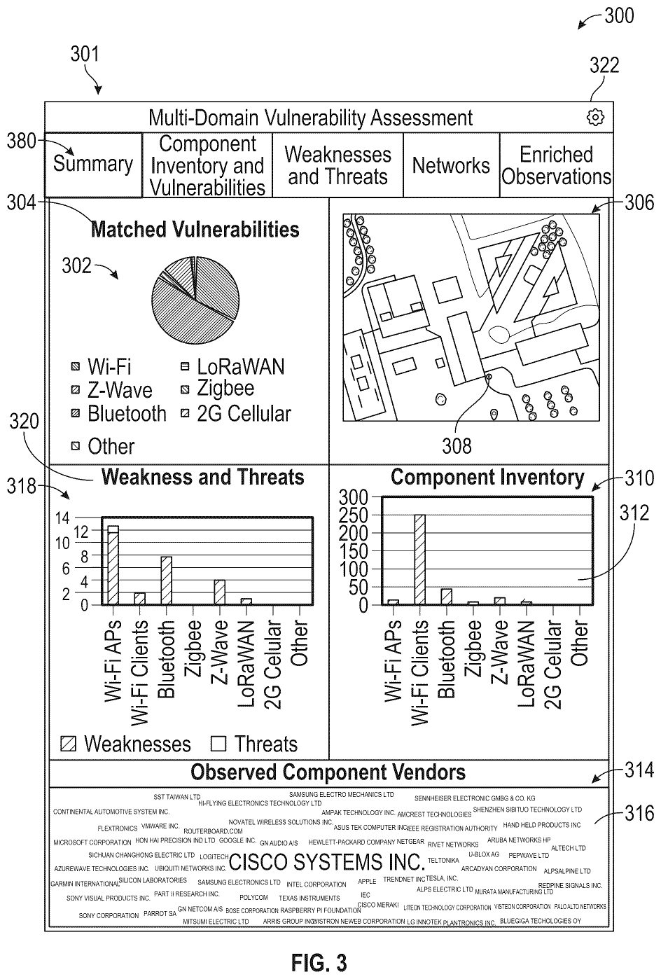

At block 112, the system can cause a user interface to display results of a multi-domain vulnerability assessment for user review. In some embodiments, the user interface is a graphical user interface that allows users to interact with the displayed results and optionally control one or more electronic devices of the system. In some embodiments, the user interface can include interfaces 300-500 described with reference to FIGS. 3-5, below. In some embodiments the system can cause the user interface to display the logical network map generated according to the method described with reference to FIG. 6.

FIG. 2 illustrates an exemplary process for determining device risk(s) for a plurality of wireless devices based on one or more determined vulnerabilities associated with the devices and/or weaknesses and/or threats associated with respective wireless communication protocols, in accordance with some embodiments. Process 200 is performed, for example, using one or more electronic devices implementing a software platform. In some examples, process 200 is performed using one or more electronic devices. In some embodiments, process 200 is performed using a client-server system, and the blocks of process 200 are divided up in any manner between the server and one or more client devices. Thus, while portions of process 200 are described herein as being performed by particular devices, it will be appreciated that process 200 is not so limited. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202, an exemplary system (e.g., one or more electronic devices) receives wireless signal data from a plurality of devices. In some embodiments, the wireless signal data are detected by a plurality of wireless signal sensors. In some embodiments, the wireless signal data include any one or more of Wi-Fi data, Bluetooth data, Z-Wave data, OT/ICS wireless data, 802.15.4 data (Thread, 6LoWPAN, ISA100.11A, SNAP, WirelessHART, Zigbee), LoRaWAN, EnOcean data, data, and/or Wideband radio-frequency data. Sensors may also collect GPS data, 2G cellular data, etc. In some embodiments, the wireless signal sensors can include either or both of commercial-off-the-shelf (COTS) and government-off-the-shelf (GOTS) based sensors. In some embodiments, the wireless signal sensors can include any one or more of Wi-Fi sensors (with or without power amplifiers), Bluetooth sensors, Z-Wave sensors, Zigbee sensors, 802.15.4 sensors, Wideband radio-frequency sensors, and/or other sensors for detecting various other signal modalities (e.g., including WirelessHart and LoRaWAN).

In some embodiments, the wireless signal sensors are enclosed in a sensor housing. In some embodiments the sensor housing is a compact case that a user can hand-carry. In some embodiments a multimode antenna, external to the compact case, is connected to the wireless signal sensors and transmits detected wireless signals to the wireless signal sensors. In some embodiments, the sensor kit includes cameras, accelerometers, gyroscopes, IMU/Compass sensors, etc. for collecting additional data for assessing vulnerabilities, weaknesses, and threats. In some embodiments the camera is a color (RGB) camera. The camera can be used to collect images of a location being scanned by the wireless signal sensors. For instance, in some embodiments, a camera could collect visual data for identifying physical entry vulnerabilities (e.g. open doors or gates) or cyber physical device vulnerabilities (e.g., security cameras, electronic door locks, badge readers, etc.). This may be done through employment of object classification techniques in image and/or video data or by manual processing. Additionally, in some embodiments, collected video data that is time synchronized with other modalities (such as the wireless signal data) could be used for later playback to provide contextual visual information alongside detected devices and vulnerabilities based on the wireless data processing pipeline.

At block 204a, the system can classify the plurality of devices based on the wireless signal data. In some embodiments, classifying the plurality of devices includes performing common platform enumeration. Common platform enumeration is a standardized method of describing and identifying classes of applications, operating systems, and hardware devices. Classifying the device can include determining a plurality of identifiers for a respective device (e.g., one or more addresses such as an IP address, one or more probable device types, one or more probable product names, one or more probable vendors, and one or more probable common platform enumerators). The system may also determine, for instance, the software running on the device, the operating system, and the operating system version. Each classification technique (e.g., Wi-Fi Taxonomy, OUI Vendor Classification/matching, etc.), described in more detail below, may produce a plurality of possible identifiers associated with each respective device based on the wireless signal data.

In some embodiments, the system can cross-correlate identifiers assigned by a plurality of classification techniques to determine a subset of most likely device classifications (including as few as a single most likely CPE associated with a device). For example, Wi-Fi taxonomy may indicate that device A could either be a GOOGLE PIXEL 6 or a DELL PRECISION 7550 Workstation. Wi-Fi Taxonomy can include generating a string based on the wireless signal data; hashing the string to generate a signature associated with a device of the plurality of devices; and classifying a respective device of the plurality of devices based on the signature. OUI Vendor classification/matching may indicate that device A is the Dell device. OUI Vendor classification/matching can include classifying a device based on a MAC address. The system can use those the two classifications to generate a refined classification that classifies device A as a Dell Precision 7550 Workstation at a higher confidence level. While the above example is described with reference to a function of two classification techniques, it should be understood that the system may combine and/or cross-correlate the device classifications produced by any number of classification techniques to determine a refined classification. Below is a more detailed description of exemplary device classification techniques that may be implemented either alone or in combination to classify devices based on wireless signal data.

In some embodiments, classifying the plurality of devices includes using one or both of passive inference techniques and active interrogation techniques. In some embodiments, the one or more passive inference techniques include any one or more of a passive probe-request frame taxonomy, a passive beacon frame taxonomy, a passive Wi-Fi protected setup (WPS) frame taxonomy, a Passive MouseJack Matching taxonomy, associate request frame taxonomy, a Bluetooth taxonomy, Passive BT-CIC Matching, passive OUI matching (e.g., OUI Vendor classification/matching techniques), Blueprinting, and/or Manufacturer/Product Lookup.

A passive probe-request frame taxonomy may include a Wi-Fi probe-request frame taxonomy, for instance, as described in Denton Gentry & Avery Pennarum, Passive Taxonomy of Wifi Clients Using MLME Frame Contests, arXiv: 1608.01725v2 (2016), https://doi.org/10.48550/arXiv.1608.01725, which is incorporated herein by reference in its entirety. Wi-Fi probe-request frame taxonomy a method applied to observed Probe and Association requests generated by the 802.11n/802.11ac chipset MAC Layer implementation, where the contents of these messages, populated by Wi-Fi chipsets and device drivers, can allow an observer to ascertain device types. In some embodiments, Wi-Fi probe-request frame taxonomy includes mapping information from unencrypted broadcasted signals to ground truth data such as an asset inventory that includes MAC addresses, vendors, and models of specific devices. In some embodiments, the asset inventory includes device operating systems and/or firmware versions. A CPE string is created based on ground truth data in the asset inventory. The broadcasted signal information is processed to obtain a signature, which can be mapped to a CPE string in the asset inventory. Passive probe-request frame taxonomy may enable classification of vendor, product, and/or version of a device.

A passive beacon frame taxonomy may include a Wi-Fi Beacon Frame Taxonomy. Wi-Fi Beacon Frame Taxonomy is a method similar to Wi-Fi Probe-Request Frame Taxonomy but leverages options and parameters available in Beacon frames to help differentiate Wi-Fi Access Point devices. Wi-Fi Protected Setup (WPS) is a network security standard designed to simplify the process of securely connecting devices to a Wi-Fi network. It aims to provide an easy and convenient method for users to set up secure connections without the need to manually configure complex encryption keys. WPS typically involves a push-button or PIN-based authentication process. In push-button mode, users press a physical or virtual button on the Wi-Fi access point and then on the client device to establish a secure connection. In PIN mode, a unique PIN is generated by the access point and entered into the client device for authentication. WPS uses several security mechanisms, including the use of a temporary network key (WPA/WPA2-PSK), which is exchanged between the access point and client device during the setup process. Notably, WPS has potential security vulnerabilities. Passive beacon frame taxonomy may enable classification of vendor, product, and/or version of a device.

In some embodiments, the one or more passive inference techniques include a passive Bluetooth taxonomy. Bluetooth devices have characteristics that are unique, manufacturer specific, or model specific that may in some cases be combined to determine the device manufacturer and model. These characteristics vary based on the device firmware specification. In some embodiments, the exemplary system determines a device's Bluetooth specification and then applies appropriate fingerprint approaches based on available data observable passively. As an example, Bluetooth Extended Inquiry (EIR), introduced in Bluetooth version 1.2, typically provides certain information about a device's capabilities and supported services, which can be incorporated into the device classification. The information transmitted through EIR can include device profiles, services, features, and limited manufacturer-provided information that may be incorporated along with other protocol-specific and device behavioral data into labeled fingerprints for device classification. Active interrogation, described further below, can provide additional useful information to determine device type.

In some embodiments, the one or more passive inference techniques include Organizationally Unique Identifier (OUI) matching. OUI vendor matching is a system used to categorize and identify network devices based on their manufacturer or vendor. An OUI is a three-byte identifier assigned by the Institute of Electrical and Electronics Engineers (IEEE) to uniquely identify network interface controllers (NICs), such as Wi-Fi adapters, Ethernet cards, and other networking devices. The OUI vendor matching system allows for easy identification of the manufacturer or vendor of a network device based on its MAC (Media Access Control) address. The MAC address is a unique identifier assigned to each network device, and the first three bytes of the MAC address correspond to the OUI. The IEEE maintains a publicly accessible database that maps OUIs to their respective vendors. In some embodiments, the system hosts an OUI-Vendor Classification/matching Service that is used to assess the vendor of each device detected by the plurality of wireless signal detectors on supported wireless signal protocols/modalities.

In some embodiments, the one or more passive inference techniques include a Bluetooth Low Energy (BLE) GATT (Generic Attribute Profile) Blueprinting technique. In some embodiments, the BLE GATT Blueprinting technique includes receiving at a BLE sensor, for instance, provided in the sensor kit. In some embodiments, a Bluetooth device address is relayed to a second Bluetooth device that acts as a “dummy” GATT client that queries GATT servers for more information. In some embodiments, the GATT client receives a services enumeration data structure from the GATT server, which can then be relayed to the system for device inference/classification.

As noted above, in some embodiments, classifying the plurality of devices includes using active interrogation techniques in addition to or alternatively to passive inference techniques. In some embodiments, the one or more active interrogation techniques include any one or more of active Bluetooth interrogation, including active BLE GATT Profile Taxonomy which may enable classification of vendor, product, and version, active Z-Wave interrogation, and active ZigBee interrogation. In some embodiments, the system can be configured such that a user can enable or disable active interrogation depending on the user's preference and objectives.

At block 206a, the system can determine one or more device vulnerabilities associated with the plurality of devices based on the classification of the plurality of devices. In some embodiments, the system automatically matches devices classified at block 204a to device vulnerabilities based on the classification of the device. In some embodiments, the system determines a plurality of vulnerabilities associated with each respective device of the plurality of devices, or each respective device of a subset of the plurality of devices. In some embodiments, determining one or more device vulnerabilities associated with the plurality of devices includes determining one or more device vulnerability identifiers associated with each of the plurality of devices based on the classification of the device.

In some embodiments, determining the one or more device vulnerabilities comprises determining a device vulnerability identifier based on the respective device code associated with the device (e.g., common platform enumerator (CPE)), wherein the device vulnerability identifier comprises a Common Vulnerabilities and Exposure identifier (CVE ID). CVE IDs are a unique, alphanumeric identifier assigned. Each CVE ID references a specific vulnerability associated with, for instance, a device or software program. In some embodiments, CPEs are matched to respective CVE IDs using a fuzzy matching algorithm. In some embodiments, determining the plurality of device risks includes matching classified devices to Common Vulnerability Scoring System (CVSS) scores. A CVSS score provides an indication of the severity of a common vulnerability enumeration (CVE).

Before, after, or simultaneously to classifying devices and determining device vulnerabilities at blocks 204a and 206a, the system can determine weaknesses and threats associated with respective devices and wireless signal protocols based on the wireless signal data. At block 204b, the system can determine one or more weaknesses and/or threats based on observations about device configuration, usage, or behavior with respect to their use of wireless communication protocols. In some embodiments, the system may determine a weakness or threat based upon detection device configuration, usage, or behavior within a respective wireless communication protocol. In some embodiments, the one or more weaknesses and/or threats are associated with Wi-Fi devices and/or protocols (e.g., Wi-Fi access point weaknesses and/or threats and Wi-Fi client weaknesses and/or threats). Wi-Fi access point weaknesses and/or threats can include any one or more of an unencrypted access point, a weakly encrypted access point, a hidden access point, a rogue access point, a rogue hotspot access point, an Evil Twin access point, inconsistent access point vendors, an unexpected access point vendor, a banned access point vendor, and access point MAC address spoofing. In some examples, an exemplary system may determine weaknesses and/or threats including Wi-Fi De-authentication Flood, BLE BleedingTooth, BLE FlipperZero, and/or compromised keys, among others.

In some embodiments the system determines that unencrypted and weakly encrypted access points are a weakness and/or threat observable in the received wireless signal data. Unencrypted access points pose several risks and can have negative implications for critical infrastructure facilities. Unencrypted access points provide network access allowing attackers to exploit vulnerabilities in connected clients or launch various types of attacks or surveillance campaigns. Weakly encrypted access points are often exploitable to close-access attackers (individuals frequently close to the pertinent network or system). Aging access points and misconfigured modern access points often inadvertently present weak or exploitable encryption. Examples of weak encryption include Wireless Encryption Protocol (WEP) and Wi-Fi Protected Access (WPA). More recent versions of Wi-Fi Protected Access (WPA2, WPA3) offer stronger security. In some cases, however, an access point aims to increase client compatibility by supporting multiple encryption options for clients, allowing an attacker to exploit a weaker option for network access. Like unencrypted access points, weakly encrypted access points allow attackers to launch attacks, exploit vulnerabilities, and conduct surveillance on infiltrated networks.

In some embodiments, the system determines that hidden access points are a weakness and/or threat observable in the received wireless signal data. Hidden access points (e.g., hidden Wi-Fi networks or closed networks) pose security risks despite not publicly broadcasting their network name (SSID). Hidden access points often require manual configuration on client devices, which can lead to configuring weak passwords; additionally, security by obscurity is not sufficient against determined attackers. Signal leakage, lack of monitoring, and misconfigurations further contribute to the risks associated with hidden networks. Implementing additional security measures and not relying solely on the hidden network feature for security is crucial for mitigating these risks and protecting the network and its data.

In some embodiments, the system determines that rogue hotspot access points are a weakness and/or threat observable in the received wireless signal data. Rogue hotspot access points often lack the robust security measures implemented in authorized networks, leaving them more susceptible to exploitation. Many mobile phones support hotspot capability which allows mobile device owners to configure their own Wi-Fi access points. Cellular carriers additionally offer dedicated 4G, LTE, and 5G mobile hotspot devices. When bridged into facility networks, hotspots potentially provide means for remote attacker ingress or data exfiltration. Their use, even when benign, may also violate facility policies. These hotspots, established without proper authorization or oversight, can be set up by employees or malicious actors seeking to bypass security measures or launch attacks. The system can flag potential rogue hotspots by identifying access points with randomized MAC addresses and/or SSIDs matching frequent defaults for mobile hotspots. Mitigations can include detecting and preventing unauthorized hotspots, implementing strict access controls, and educating employees about the risks associated with connecting to untrusted networks.

In some embodiments, the system determines that a suspected Evil Twin attack is a weakness and/or threat observable in the received wireless signal data. An Evil Twin Access Point is similar to a rogue access point except that it engages in deceptive measures intended to deceive clients into joining what they believe is a trusted access point, potentially facilitating man-in-the-middle attacks or other attacks. In some embodiments, an Evil Twin attack is determined by the system to be a threat.

In some embodiments, the system determines that inconsistent access points are a weakness and/or threat observable in the received wireless signal data. Inconsistent access points, or a variety of access points observable at a facility (vendors, products, versions) implies inconsistent configuration across those access points and potentially burdensome administrative overhead necessary to maintain a strong security posture. In accordance with detecting an unexpected vendor, the system can determine that an unexpected vendor is a weakness and/or threat in the received wireless signal data.

In some embodiments, the system determines that suspected access point MAC address spoofing is a weakness and/or threat observable in the received wireless signal data. In some cases, conflicting data or classifications may indicate an access point that may represent a threat. For example, when a high-confidence Wi-Fi Beacon Frame-based classification conflicts with an OUI-based vendor matching, then the system may determine that the access point is spoofing its MAC address.

Wi-Fi client weaknesses and/or threats can include any one or more of an unexpected client vendor, a client joining an unencrypted access point, a client joining a weakly encrypted access point, an unencrypted ad-hoc network, an unauthorized ad-hoc network, a banned vendor, and client MAC address spoofing. In some embodiments, the system can determine that a client suspected of MAC address spoofing may represent a threat. In some cases, conflicting data and classifications may indicate a Wi-Fi client that may represent a threat. For example, when a Wi-Fi Probe Request Frame-based classification conflicts with an OUI-based vendor matching, then the system may determine that the Wi-Fi client is spoofing its MAC address.

In some embodiments, the one or more weaknesses and/or threats are associated with Bluetooth devices and/or protocols. Bluetooth device weaknesses and/or threats can include any one or more of always-discoverable devices, weak or vulnerable encryption, unencrypted data communications, an unexpected vendor, a banned vendor. For instance, a device in discoverable mode is more susceptible to unauthorized connection attempts or exposing security vulnerabilities. Mitigations can include secure pairing or authentication to protect against unauthorized access.

In some embodiments, the one or more weaknesses and/or threats are associated with devices communicating using a Z-Wave protocol. While Z-Wave has gained popularity for its wide device compatibility and extensive network range, there are weaknesses associated with the protocol and chipsets. In some embodiments, Z-Wave weaknesses and/or threats include unencrypted device communications. Z-Wave devices based on Silicon Labs 100, 200, and 300 series chipsets do not support encryption. Likewise, Z-Wave devices based on Silicon Labs 500 series chipsets using CRC-16 encapsulation do not implement encryption or replay protection. Devices operating on unencrypted networks are vulnerable to passive or active interrogation of detailed device information, potentially revealing additional vulnerabilities. Devices operating on unencrypted networks are also susceptible to various types of attacks.

In some embodiments, the one or more weaknesses and/or threats are associated devices communicating using a ZigBee protocol. Zigbee is a wireless communication protocol widely used in home automation and IoT applications, providing a reliable and low-power network for connecting and controlling smart devices. It operates on the 2.4 GHz frequency band, offering a mesh network topology that enables devices to form self-healing and self-configuring networks. Zigbee has gained popularity for its robustness, flexibility, and interoperability among various devices. The system is capable of detecting various weaknesses and/or threats manifested by ZigBee devices and networks. In some embodiments, the system can determine that unencrypted device communications are a weakness and/or threat in accordance with detecting communications using the ZigBee protocol in the wireless signal data.

In some embodiments, the one or more weaknesses and/or threats are associated with devices communicating using a WirelessHART protocol. WirelessHART is a popular wireless communication standard specifically designed for industrial process automation and control systems. While WirelessHART offers several advantages such as increased flexibility and cost savings, it is not without its weaknesses. Weaknesses and/or threats associated with the WirelessHART protocol include potential security vulnerabilities, limited bandwidth, and coexistence challenges.

In some embodiments, the one or more weaknesses and/or threats are associated with devices communicating using a LoRaWAN protocol. LoRaWAN (Long Range Wide Area Network) is a wireless communication protocol designed for low-power, wide-area networks that enables long-range connectivity for Internet of Things (IoT) devices. While LoRaWAN offers several security features, it also has some potential weaknesses observable from the close-access vantage point.

In some embodiments, the one or more weaknesses and/or threats are associated with 2G Cellular. In some embodiments, the system determines one or more 2G Cellular weaknesses and/or threats in accordance with detecting a 2G cellular network in the wireless signal data. 2G cellular networks include vulnerabilities that make them susceptible to various security threats. For example, 2G cellular networks lack of robust encryption standards. Unlike newer generations of cellular technology, 2G networks utilize weak encryption algorithms, such as the outdated A5/1 and A5/2 algorithms, which can be easily compromised. This makes it relatively simple for attackers to intercept and decode communications, including voice calls and text messages, potentially compromising sensitive information. Furthermore, 2G networks lack proper authentication mechanisms, making them vulnerable to subscriber identity spoofing attacks. Attackers can manipulate signaling messages to impersonate legitimate subscribers, gaining unauthorized access to network services, and potentially engaging in fraudulent activities. These vulnerabilities have prompted the phasing out of 2G networks in favor of more secure and advanced cellular technologies. Although 2G cellular is phased out in the United States, it is still used in some parts of the world and many consumer handsets support backwards compatibility with 2G infrastructure.

Numerous potential weaknesses and/or threats are associated with 2G base stations. For example, in a downgrade attack, an attacker may attempt to force handsets to communicate with a rogue 2G base station by denying service to legitimate cellular infrastructure. In some embodiments, the system determines that a 2G base station is a weakness and/or threat in accordance with detecting a 2G base station in the wireless signal data.

At block 208, the system can determine a plurality of device risks for the plurality of devices based on the device vulnerabilities and/or the weaknesses and/or threats. In some embodiments, a device risk is determined for each of the devices classified based on the wireless signal data. In some embodiments, an aggregate/composite device risk is determined for each unique device. In some embodiments, an aggregate/composite device risk is determined for each unique device per each wireless communication protocol/modality. For instance, aggregate/composite device risk for each device may be determined algorithmically based on a risk score assigned to each vulnerability associated with a respective device and/or each protocol weakness and/or threat associated with the respective device. The composite device risk may be a weighted combination of the risk score associated with the vulnerabilities determined based on device classification, and/or the determined weaknesses and/or threats associated with a respective device. As such, all or a subset of all device risks for a respective device determined based on each CVE associated with a respective device and/or each weakness and/or threat associated with a respective device may be combined into a composite/aggregate device risk.

In some embodiments, determining the plurality of device risks includes comparing the one or more device vulnerabilities to a list of predetermined device risks associated with the one or more device vulnerabilities. For instance, the system may automatically correlate a CVE ID with one or more device risks included in the National Vulnerability Database. In some embodiments, the system may further determine a threat of exploitation of a device vulnerability. For instance, the system may automatically correlate a CPE or CVE ID with an active exploitation of the CPE or CVE ID based on an exploited vulnerability published by the Department of Homeland Security's Critical Infrastructure Security Agency. In some embodiments, the system may combine threat information with device risks to determine a more comprehensive device risk.

In some embodiments, for devices where only the vendor is known (and no higher precision classification is available), the system may determine device risk as a function of the vendor's prevalence in Cyber Threat Intelligence (CTI) and within vulnerability datasets. For devices with type classification having, at least, vendor and product name, the system may determine device risk as a function of the level of precision of device classification, the set of vulnerabilities associated with the device, the set of vulnerabilities associated with the device having known exploits, and other factors.

At block 210, the system can generate an output. In some embodiments, the output includes an indication of any one or more of the device risks, the device vulnerabilities, the weaknesses and/or threats, the classification of the plurality of devices, and the wireless communication protocol associated with the respective devices of the plurality of detected devices. In some embodiments the output includes an indication of the unique observable devices per wireless communication protocol/modality and a corresponding device risk associated with the device. In some embodiments, the device risks, device vulnerabilities, and/or weaknesses and/or threats are output in accordance with a determined importance or severity of the device risk (i.e., the level of risk). For example, information associated with a device determined to have relatively high associated device risk (compared to other devices detected based on the wireless signal data) can be displayed at or near the top of a list and information associated with a device determined to have relatively low device risk can be displayed at or near the bottom of the list. As another example, in response to determining the presence of high-risk devices or high-priority vulnerabilities, the system may generate a combination of outputs (i.e., audio, visual, and haptic alerts). In some embodiments, the output includes a recommended mitigation for any one or more of the device risks, device vulnerabilities, and weaknesses and/or threats. The mitigation recommendations may be prioritized according to the severity or level of the risk or vulnerability.

In some embodiments, the output includes one or more alerts associated with any one or more of the determined device risks, device vulnerabilities, and weaknesses and/or threats. In some embodiments, the alert is any combination of an audio alert, a haptic alert, and/or a visual alert. In some embodiments, the output is provided on a graphical user interface, such as the graphical user interface described below with reference to FIGS. 3-5.

In some embodiments, the output includes a geospatial view that maps information associated with detected devices during a multi-domain vulnerability assessment. In some embodiments, a user can configure the geospatial view to activate or deactivate one or more layers of the geospatial view. In some embodiments, the one or more layers include satellite imagery, street maps, a wireless signal sensor heatmap, and device indicators representing detected devices. In some embodiments, the indicators of detected devices are associated with a respective wireless communication protocol. For instance, device indicators displayed on the geospatial view associated with a Wi-Fi signal may be displayed as a first color or shape and device indicators displayed on the geospatial view associated with a Bluetooth signal may be displayed as a second color or shape. The device indicators can be displayed on geospatial view at a location associated with the detected device (i.e., at the approximate geographic location where the device is located).

FIGS. 3-8 illustrate exemplary graphical user interfaces 300-700 for controlling and displaying information about devices detected in wireless signal data, in accordance with some embodiments. Graphical user interfaces 300-700 can be displayed using one or more electronic devices, such as the one or more electronic devices of the multi-domain vulnerability assessment system described above with reference to FIGS. 1 and 2. Graphical user interfaces 300-700, in some embodiments, enable users of the one or more electronic devices to interact with one or more other components (e.g., using wired or wireless communication protocols) of a multi-domain vulnerability assessment system, such as system 100 described above with reference to FIG. 1. Sending and receiving information about one or more wireless devices using interfaces 300-700 may allow users to send and receive accurate, real-time information about the vulnerabilities associated with one or more wireless devices and wireless communication protocols detected in wireless signal data.

Interfaces 300, 400, 500, 600, and 700 may be displayed via display 301, which may be provided on a mobile electronic device, such as a smart-phone or tablet, desktop computer, laptop, or any other electronic device configured to display one or more interfaces 300-700 and to receive one or more inputs from a user to control operation of the interface and operation of a multi-domain vulnerability assessment system, such as system 100. The interfaces 300-700 may be configured to receive a user input via a touch-screen or one or more other input devices alternately or additionally to a touch-screen, such as a mouse, a keyboard, one or more physical buttons or keys, voice command, etc.

Below, interfaces 300-700 are discussed with respect to FIGS. 3-8 in greater detail. Interfaces 300-700 may, in some embodiments be interrelated interfaces of a single program or application configured to be used in connection with one another. For example, interfaces 300-700 may be different screens that are selectively accessible from an application or other computer program configured to work in conjunction with one or more electronic devices, including one or more portable wireless signal sensors, radio-frequency antennas, and/or other electronic devices to perform a multi-domain vulnerability assessment. In some embodiments, interfaces 300-700 each respectively include user selectable icons 380 that, when selected, cause an interface of interfaces 300-700 associated with the selected icon to be displayed.

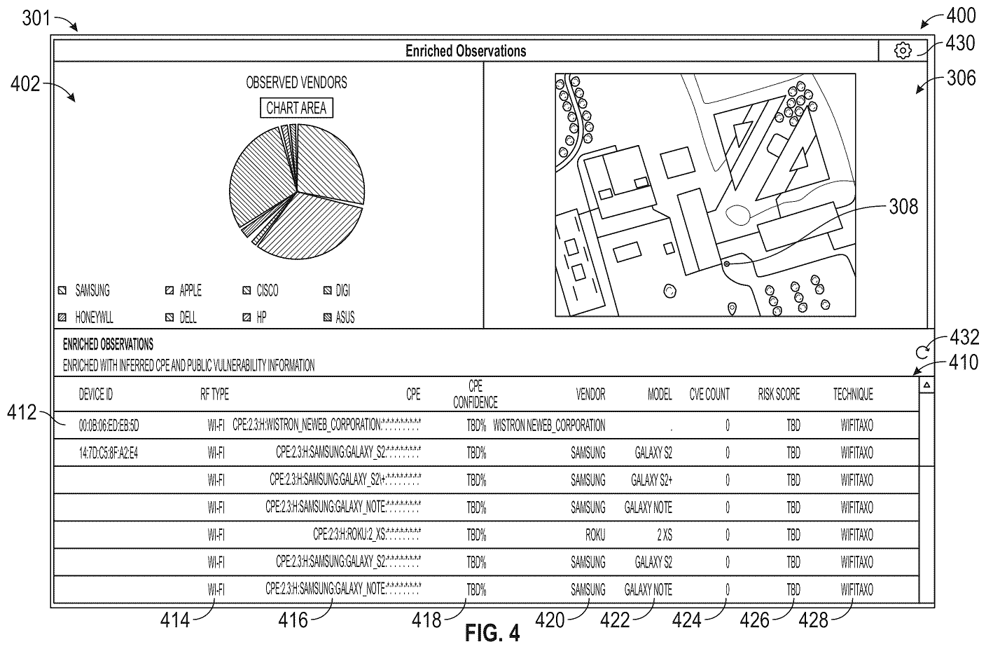

FIG. 3 shows a summary dashboard interface 300. The summary dashboard interface 300 may include a number of detections chart 302. In some embodiments, the number of detections chart 302 depicts a number of detected devices per wireless communication protocol (i.e., modality). In some embodiments, the number of detections chart comprises a user selectable icon 304, which, when selected by a user causes display of an enriched observations dashboard 400, shown in FIG. 4. The enriched observations dashboard 400 includes a matched vulnerabilities chart 402 (titled “Observed Vendors” in FIG. 4). In some embodiments, the matched vulnerabilities chart illustrates the distribution of device vendors detected in wireless signal data. In some embodiments, enriched observations dashboard 400 includes a geospatial view 306 that maps information associated with detected devices during a multi-domain variability assessment. In some embodiments, a user can configure the geospatial view 306 to activate or deactivate one or more layers of the geospatial view. In some embodiments, the one or more layers include satellite imagery, street maps, a wireless signal sensor heatmap, and device indicators 308 representing detected devices. In some embodiments, the indicators of detected devices are associated with a respective wireless communication protocol. For instance, device indicators displayed on the geospatial view 306 associated with a Wi-Fi signal may be displayed as a first color or shape and device indicators displayed on the geospatial view 306 associated with a Bluetooth signal may be displayed as a second color or shape. The device indicators 308 can be displayed on geospatial view 306 at a location associated with the detected device (i.e., at the approximate geographic location where the device is located).

In some embodiments, the enriched observations dashboard 400 includes an enriched observations section 410. In some embodiments, the enriched observations section 410 displays information associated with a plurality of devices detected based on received wireless signal data, for instance as described above with reference to FIGS. 1 and 2. In some embodiments, the enriched observations section 410 includes a plurality of device IDs, which may, for example, be extracted from wireless signal data and used to classify the device. In some embodiments, enriched observations section 410 includes, for each detected device, a wireless signal protocol/RF type 414 (such as Wi-Fi, Bluetooth, etc.), a CPE classification 416, a CPE confidence 418 associated with the classification, a vendor name 420, a device model 422, a CVE count 424 (i.e., a count of common vulnerability enumerators assigned to the device), a device risk 426, and a classification technique 428. In some embodiments, enriched observations section 410 includes the number of observations yielding a device classification. In some embodiments, the enriched observations section includes a plurality of rows and columns, each row associated with a respective device and each column in that row containing information associated with the respective device. It should be understood that while the enriched observations section 410 is illustrated herein as a table with rows and columns as described above, any number of different formats could be implemented to display the information described herein without deviating from the scope of the claims.

In some embodiments enriched observations dashboard 400 includes one or more user selectable icons. In some embodiments, enriched observations dashboard 400 includes settings icon 430, which when selected by a user, displays a settings interface configured to enable a user to modify one or more settings of one or more electronic devices. In some embodiments, enriched observations dashboard 400 includes a refresh icon 432, which when selected by a user, causes the enriched observations dashboard 400 to display up-to-date information associated with a plurality of detected devices.

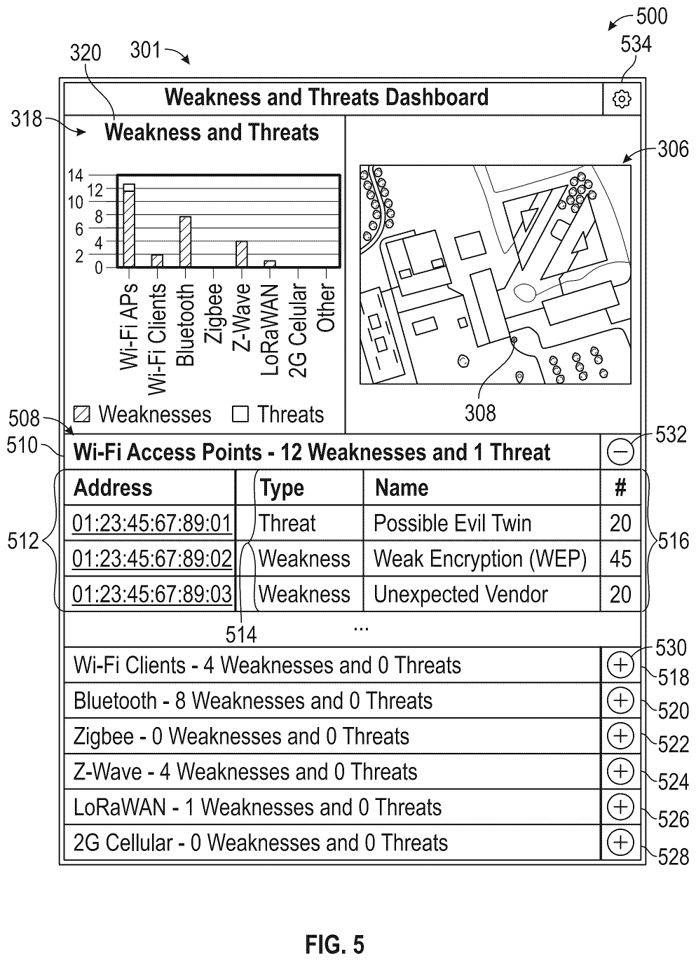

Returning to the summary dashboard 300 of FIG. 3, the summary dashboard also includes the geospatial view 306. In some embodiments, summary dashboard includes a weaknesses and threats chart 318, a component inventory chart 310, and an observed vendors word cloud view 314. In some embodiments, the weaknesses and threats chart 318 displays weaknesses and threats associated with devices using one or more of the respective wireless communication protocols (for instance, the weaknesses and/or threats described with reference to the method 200 of FIG. 2). In some embodiments, the weaknesses and threats chart includes a user selectable icon 320 which, when selected by a user, causes display of a weaknesses and threats dashboard 500, as shown in FIG. 5. In some embodiments, selection of a user selectable icon 380 labeled “Weaknesses and Threats” provided on any of interfaces 300-700 may also cause the system to display the weaknesses and threats dashboard 500. In some embodiments, the weaknesses and threats dashboard 500 includes the weaknesses and threats chart 318 and the geospatial view 306. In some embodiments, the weaknesses and threats chart 318 includes a weaknesses and threats section 508. In some embodiments, the weaknesses and threats section 508 includes a list of observed weaknesses and threats. In some embodiments, the weaknesses and threats include any of those described above with reference to FIG. 2, including Wi-Fi access point weaknesses and/or threats 510, Wi-Fi client weaknesses and/or threats 518, Bluetooth device weaknesses and/or threats 520, ZigBee device weaknesses and/or threats 522, Z-Wave device weaknesses and/or threats 524, LoRaWAN device weaknesses and/or threats 526, and 2G cellular device weaknesses and/or threats 528. In some embodiments, the weaknesses and/or threats section 508 includes an indication of a number of threats and a number of weaknesses associated with each of the aforementioned categories of weaknesses and/or threats.

In some embodiments, weaknesses and/or threats section 508 includes a plurality of user selectable icons of a first type 530 and a second type 532. In some embodiments, a user selecting the first type 530 of user selectable icon causes display of additional information 516 associated with a respective category of weaknesses and/or threats. In some embodiments, a user selecting the second type 532 of user selectable icon collapses the display (ceases to display) the additional information 516 associated. In some embodiments, selecting the first type of user selectable icon causes the respective user selectable icon to transition to the second type 532 of user selectable icon. In some embodiments, additional information 516 includes additional identifying information associated with respective weaknesses and/or threats, including a type (threat or weakness) a name (e.g., Possible Evil Twin, Weak Encryption, Unexpected Vendor, etc.), and an address.

As shown in FIG. 6, which illustrates an alternative version of the weaknesses and threats dashboard 500, the weaknesses and threats dashboard 500 may also include a filter 580 that allows a user to filter through weaknesses and threats displayed on the weaknesses and threats dashboard 500. In some embodiments, the filter 580 enables searching and/or filtering using regular expressions. Also as shown in FIG. 6, the weaknesses and threats dashboard 500 may include a summary description of each identified weakness or threat, a confidence associated with the identified weakness or threat, and a severity level associated with the identified weakness or threat. In some embodiments, in accordance with receiving a user selection associated with the filter 580, the weaknesses and threats dashboard 500 may display one or more selected subsets of weaknesses or threats associated with the user selection. For instance, in accordance with a user selection received using filter 580 the weaknesses and threats dashboard may display only high (and/or medium and/or low) severity weaknesses and/or threats or high (and/or medium and/or low) confidence weaknesses and/or threats. Filter 580 may enable filtering identified weaknesses and/or threats by type (e.g., weakness or threat), RF signal modality, identifier, vendor, summary, confidence, and/or severity.

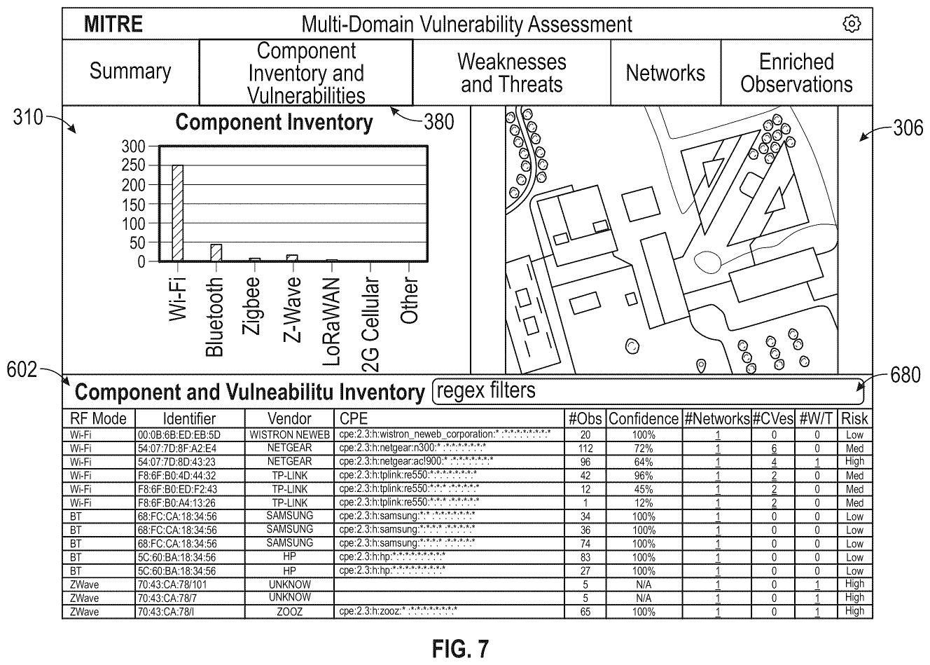

Returning to the summary dashboard 300 of FIG. 3, in some embodiments, the component inventory chart 310 of summary dashboard 300 illustrates the distribution of uniquely addressable devices/components reconciled over all observed wireless communication protocols/modalities. In some embodiments, the component vendors world cloud view 314 illustrates the distribution of vendors or manufacturers associated with observed device/component inventory. In some embodiments, the component inventory chart 310 includes a user selectable icon 312 which, when selected by a user, results in the system causing display of a component inventory dashboard 600, as shown in FIG. 7. In some embodiment, component inventory dashboard 600 includes the component inventory chart 310 and geospatial view 306. In some embodiments, component inventory dashboard includes a component and vulnerability table 602. In some embodiments, the component and vulnerability table is configured to be searchable/filterable using a filter 680. In some embodiments, in accordance with receiving a user input via filter 680, the component inventory dashboard 600 may filter results displayed on the component and vulnerability table 602 by any of RF signal modality, device identifier, vendor, CPE, number of observations associated with a device, confidence score, number of networks, CVE count, weaknesses and threats associated with the device, and risk level, in a manner similar to that described above with regard to filter 580.

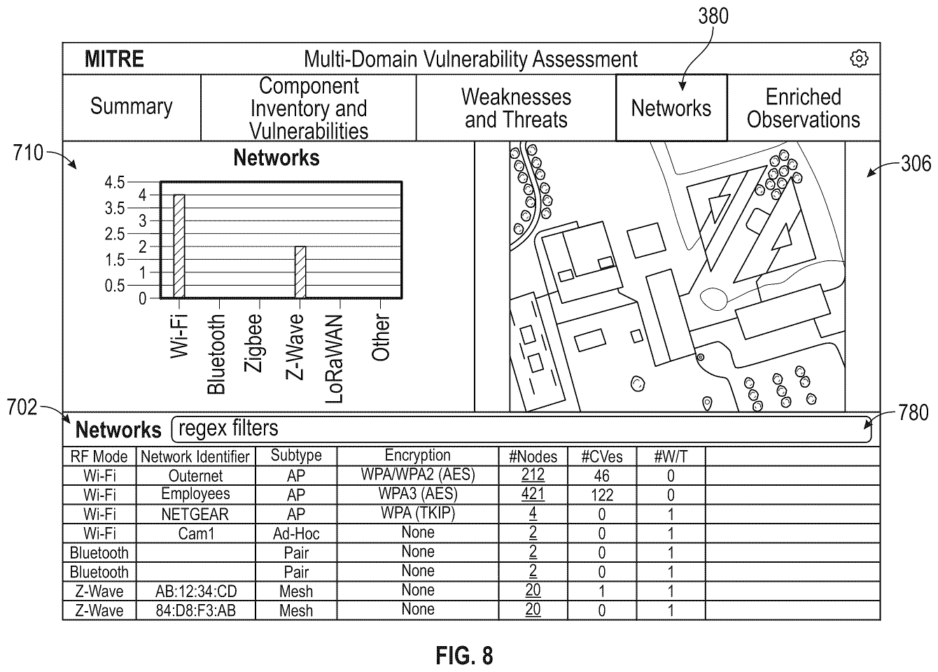

In some embodiments, in accordance with receiving a user selection of a user selectable icon 380 associated with a networks dashboard 700, the system may cause display of the networks dashboard 700, as shown in FIG. 8. In some embodiments, the networks dashboard includes a networks table 702 that may include information associated with networks detected based on the wireless signal data. The networks table 702 may include RF signal modalities, network identifiers (such as OUTERNET, NETGEAR, Cam1, etc.), network subtypes (such as AP, Ad-Hod, Pair, Mesh, etc.), encryption type (WPA, WPA2, WPA3, none, etc.), number of network nodes, number of identified CVEs associated with a respective network, and/or number of identified weaknesses and/or threats associated with a respective network. In some embodiments, the networks table 702 may be filterable using a filter 780, in a manner similar to the filters 580 and 680 described above. The filter 780 may enable a user to filter according to any of the categories of information in the network table 702, including the aforementioned categories (network subtype, number of network nodes, etc.).

In some embodiments, it may be beneficial for the system to determine relationships and communication patterns between devices and respective component devices (device subcomponents) detected in the wireless signal data and generates logical network maps based on these relationships and communication patterns. Logical network maps provide a useful visual representation of a network that allows a user to quickly identify connections between devices in the network.

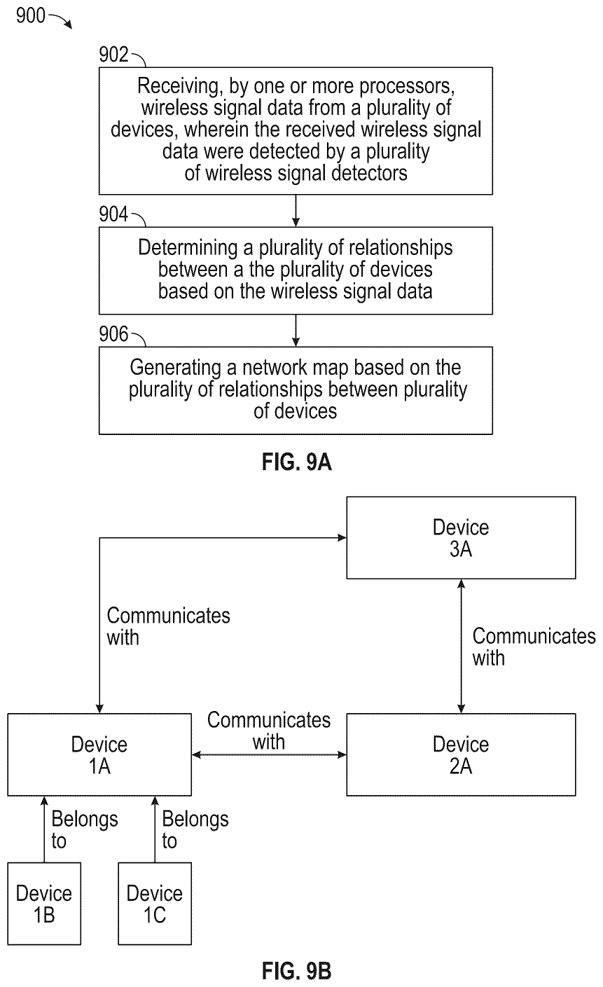

FIG. 9A illustrates an exemplary process for generating a network map of device relationships and communications, in accordance with some embodiments. Process 900 is performed, for example, using one or more electronic devices implementing a software platform. In some examples, process 900 is performed using one or more electronic devices. In some embodiments, process 900 is performed using a client-server system, and the blocks of process 900 are divided up in any manner between the server and one or more client devices. Thus, while portions of process 900 are described herein as being performed by particular devices, it will be appreciated that process 900 is not so limited. In process 900, some blocks are, optionally, combined, the order of some blocks is, optionally, changed, and some blocks are, optionally, omitted. In some examples, additional steps may be performed in combination with the process 900. Accordingly, the operations as illustrated (and described in greater detail below) are exemplary by nature and, as such, should not be viewed as limiting.

At block 902, an exemplary system can receive wireless signal data from a plurality of devices, wherein the received wireless signal data were detected by a plurality of wireless signal detectors. At block 904, the system can determine a relationship between a first device and a second device of the plurality of devices based on the wireless signal data. In some embodiments, the relationship is a hierarchical relationship between the first device and the second device. For example, the second device may be a subcomponent of the first device or vice versa. In some embodiments, the relationship may be a communication between the first device and the second device. In some embodiments, the system determines radio-frequency communications between the plurality of devices detected in the wireless signal data. For instance, the first device may be a Wi-Fi client and the second device may be an access point and the devices may communicate to establish a connection between the client and the access point. As another example, the communication may be a communication sent between the first and second device via a Bluetooth serial connection. At block 906, the system can generate a network map based on the plurality of relationships between plurality of devices. The network map can illustrate relationships (including hierarchical relationships) and radiofrequency communications between the plurality of devices. In some embodiments, the map includes a plurality of nodes, each node associated with a device. In some embodiments, one or more nodes are connected to one or more other nodes of the map by edges. In some embodiments, the edges define a relationship between the devices that the nodes represent. In some embodiments, the system displays the generated network map to a user, for instance at an interface of a device.

FIG. 9B illustrates an exemplary network map according to some embodiments. In some embodiments, the network map may be generated according to the method 900 of FIG. 9A. In some embodiments, the map includes a plurality of nodes, each node associated with a device detected based on wireless signal data. For instance, as shown in FIG. 9B, a plurality of nodes respectively representing devices 1A, 1B, 1C, 2A, and 3A are included in the map. In some embodiments, one or more nodes are connected to one or more other nodes of the map by edges. In some embodiments, the edges define a relationship between the devices that the nodes represent. For instance, a node representing device 1A is connected to respective nodes representing devices 1B, 1C, 2A, and 3B by edges respectively representing relationships between device 1A and each of the other devices. The edges connecting a node representing device 1A to nodes representing 1B and 1C indicate that devices 1B and 1C are part of device 1A. The edges connecting the node representing device 1A to nodes representing devices 2A and 3A indicate that device 1A communicates with devices 2A and 3A. Likewise, the edge linking the nodes representing devices 2A and 3A indicates that devices 2A and 3A communicate with one another.

In some embodiments, the network map comprises a plurality of user affordances that enable a user to interact with the network map. For instance, one or more of the nodes may be user selectable icons. In some embodiments, in accordance with receiving a user selection of a node, an exemplary system displays (e.g., via the interface) additional associated with the device the node represents and/or any devices represented by nodes connected to the selected node. The additional information may include any of the information determined based upon the wireless signal data as described throughout. For instance, vulnerabilities, weaknesses, threats, device risks, vendors, locations, signal type (e.g., Wi-Fi, Bluetooth, etc.), CPE, CVE ID, CVSS, weakness and/or threat severity, and so on. In some embodiments, the network map includes a plurality of user selectable affordances that enable a user to navigate to different regions of the map, zoom in or zoom out, or otherwise alter the manner in which information is displayed in the network map. A user may zoom in on the map down to the individual device level and zoom out on the map to view a logical network map of the entire network. A user may also activate or deactivate aspects of the network map associated with different wireless communications protocols. In some embodiments, the network map may be overlayed on a geographical map, such as geospatial view 306. In some examples, logical network maps may be generated for each campaign (e.g., temporally and spatially bounded data collection and analysis activities). Network maps associated with a particular AOR can thus be updated and/or compared over time to identify changes to the network topology.

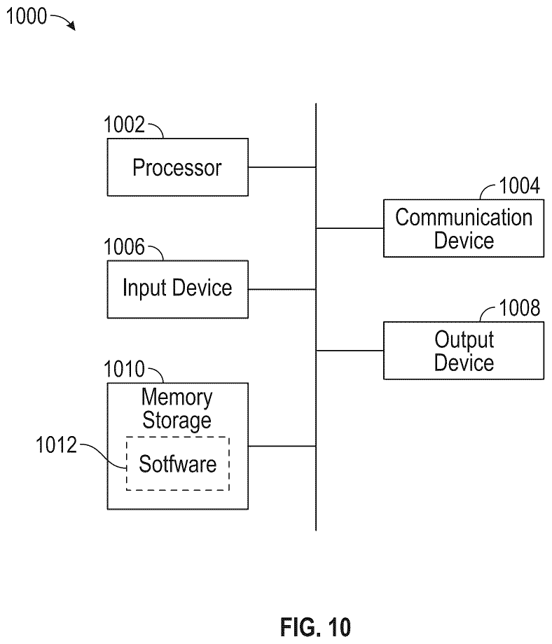

FIG. 10 depicts an exemplary computing device 1000, in accordance with one or more examples of the disclosure. Device 1000 can be a host computer connected to a network. Device 1000 can be a client computer or a server. As shown in FIG. 10, device 1000 can be any suitable type of microprocessor-based device, such as a personal computer, workstation, server, or handheld computing device (portable electronic device) such as a phone or tablet. The device can include, for example, one or more of processors 1002, input device 1006, output device 1008, storage 1010, and communication device 1004. Input device 1006 and output device 1008 can generally correspond to those described above and can either be connectable or integrated with the computer.

Input device 1006 can be any suitable device that provides input, such as a touch screen, keyboard or keypad, mouse, or voice-recognition device. Output device 1008 can be any suitable device that provides output, such as a touch screen, haptics device, or speaker.

Storage 1010 can be any suitable device that provides storage, such as an electrical, magnetic, or optical memory, including a RAM, cache, hard drive, or removable storage disk. Communication device 1004 can include any suitable device capable of transmitting and receiving signals over a network, such as a network interface chip or device. The components of the computer can be connected in any suitable manner, such as via a physical bus or wirelessly.

Software 1012, which can be stored in storage 1010 and executed by processor 1002, can include, for example, the programming that embodies the functionality of the present disclosure (e.g., as embodied in the devices as described above).

Software 1012 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1010, that can contain or store programming for use by or in connection with an instruction execution system, apparatus, or device.

Software 1012 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1000 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, TI or T3 lines, cable networks, DSL, or telephone lines.

Device 1000 can implement any operating system suitable for operating on the network. Software 1012 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

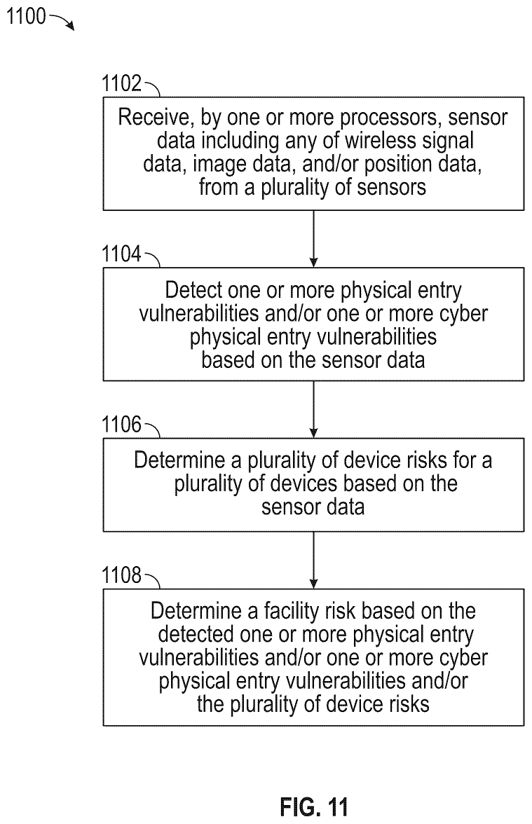

FIG. 11 illustrates an exemplary method for determining a facility risk based on physical entry vulnerabilities, cyber physical entry vulnerabilities, and/or device risks. Process 1100 is performed, for example, using one or more electronic devices implementing a software platform. In some examples, process 1100 is performed using one or more electronic devices. In some embodiments, process 1100 is performed using a client-server system, and the blocks of process 1100 are divided up in any manner between the server and one or more client devices. Thus, while portions of process 1100 are described herein as being performed by particular devices, it will be appreciated that process 1100 is not so limited. In process 1100, some blocks are, optionally, combined, the order of some blocks is, optionally, changed, and some blocks are, optionally, omitted. In some examples, additional steps may be performed in combination with the process 1100. Accordingly, the operations as illustrated (and described in greater detail below) are exemplary by nature and, as such, should not be viewed as limiting.

At block 1102, an exemplary system may receive, by one or more processors, sensor data including any of wireless signal data, image data, and/or position data, from a plurality of sensors. Wireless signal data may be collected from a plurality of wireless devices by a multi-modal wireless data collection and edge processing sensor kit. In some embodiments, the plurality of wireless devices are located within or near a specific geographic location or facility, such as facility 101. In some embodiments, the wireless signal data include any one or more of Wi-Fi data, Bluetooth data, Z-Wave data, Zigbee data, Wideband radio-frequency data, and GPS data. In some embodiments, the wireless signal data are detected by a plurality of wireless signal sensors included in a portable multi-modal wireless data collection and edge processing kit, which may include sensor hardware and corresponding software. In some embodiments, the wireless signal sensors can include either or both of commercial-off-the-shelf (COTS) and government-off-the-shelf (GOTS) based sensors. In some embodiments, the wireless signal sensors can include any one or more of Wi-Fi sensors (with or without power amplifiers), Bluetooth sensors, Z-Wave sensors, Zigbee sensors, IMU/compass sensors, Wideband radio-frequency sensors, and GPS sensors. In some embodiments, the wireless signal sensors can be configured for radio-frequency signal collection and edge processing. In some embodiments, each of the wireless signal detectors is configured to detect wireless signals of a respective wireless signal protocol of a plurality of wireless signal protocols (e.g., Bluetooth, Wi-Fi, Z-Wave, etc.).

In some embodiments, the wireless signal sensors are enclosed in a sensor housing. In some embodiments the sensor housing is a compact case that a user can hand-carry. In some embodiments a multimode antenna is external to the compact case is connected the wireless signal sensors and transmits detected wireless signals to the wireless signal sensors. In some embodiments, the sensor kit includes cameras, accelerometers, etc. for collecting additional data for assessing vulnerabilities, weaknesses, and threats. In some embodiments the camera is a color (RGB) camera. The camera can be used to collect images of a location being scanned by the wireless signal sensors. For instance, in some embodiments, a camera could collect visual data for identifying physical entry vulnerabilities (e.g. open doors or gates) or cyber physical device vulnerabilities (e.g., security cameras, electronic door locks, badge readers, etc.). This may be done through employment of object classification techniques in image and/or video data or by manual processing. Additionally, in some embodiments, collected video data that is time synchronized with other modalities (such as the wireless signal data) could be used for later playback to provide contextual visual information alongside detected devices and vulnerabilities based on the wireless data processing pipeline.

At block 1104, the exemplary system may detect one or more physical entry vulnerabilities and/or one or more cyber physical entry vulnerabilities based on the sensor data. For instance, one or more object detection models, such as a trained classifier, may be applied to the image data to detect physical entry vulnerabilities including open doors, gates, windows, or other potential physical entry vulnerabilities and/or cyber physical device vulnerabilities such as security cameras, electronic door locks, badge readers, etc. In some embodiments, the one or more physical entry vulnerabilities and/or one or more cyber physical entry vulnerabilities may be detected by manual review of the sensor data.

At block 1106, the exemplary system may determine a plurality of device risks for a plurality of devices based on the sensor data in the manner described throughout this disclosure. At block 1108, the system may determine a facility risk based on the detected one or more physical entry vulnerabilities and/or one or more cyber physical entry vulnerabilities and/or the plurality of device risks. For instance, the system may determine a risk associated with the one or more physical entry vulnerabilities and/or one or more cyber physical entry vulnerabilities and determine an overall facility risk based on the risk associated with the one or more physical entry vulnerabilities and/or one or more cyber physical entry vulnerabilities in combination with the plurality of device risks. The system may determine an overall facility risk based on any combination of identified vulnerabilities, weaknesses, and threats associated with devices and/or wireless protocols as described herein. Determining facility risk enables the system to recommend prioritizing mitigation efforts at relatively high-risk facilities over relatively low-risk facilities.

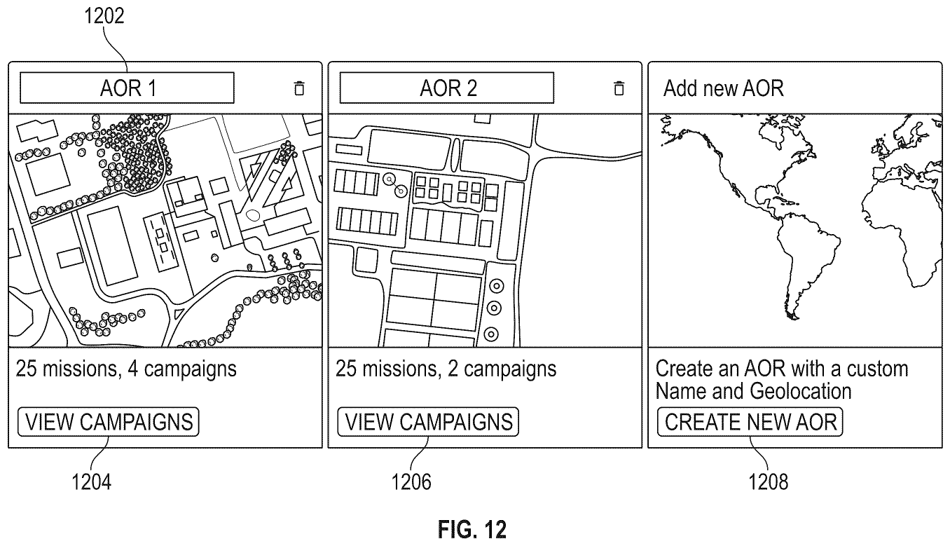

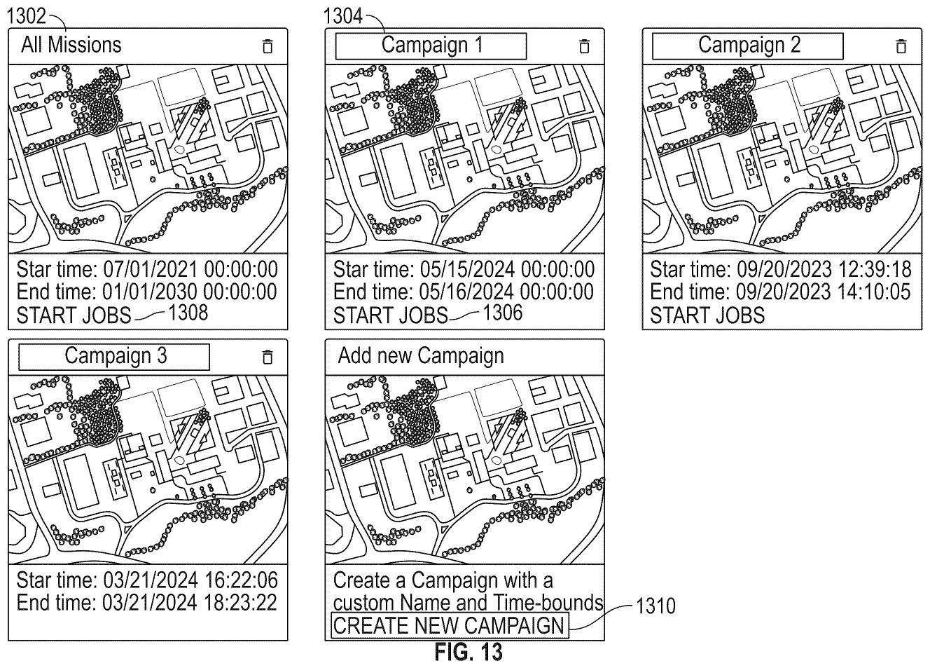

FIG. 12 illustrates another interactive user interface 1200 that enables a user to define one or more spatial Areas of Regard (AORs) 1202 within which wireless signal data is collected and analyzed. Interface 1200 includes an interactive affordance for creating an AOR, which enables a user to define a geospatial region within which data from one or more data collection activities (which may be referred to herein as campaigns and may include or be performed using any of the aspects of method 200 and the system of FIG. 1 described above) are collected an analyzed. Affordances 1204 and 1206 enable a user to access information associated with campaigns associated with two different AORs. Selection of either affordance 1204 or 1204 may enable a user to access interface 1300 depicted in FIG. 13. Interface 1300 may enable a user to define geographically and temporally bounded campaigns, such as Campaign 1 labeled 1304, by selecting affordance 1310 to create a new campaign. Campaigns may define a geographic area and time within which collected signal data may be analyzed as described herein (e.g. to identify vulnerabilities, weaknesses, and threats). The ability to define campaigns associated with various AORs may be advantageous such that users of the systems disclosed herein can validated expected results (e.g., validating a planned device is included in a network), identify unplanned devices which may represent a threat, etc. Users can also designate campaigns as baselines and compare subsequent campaigns to the baseline to determine changes in network configuration. Interface 1300 may include affordances 1306 associated with each campaign that enable a user to start jobs (e.g., wireless signal data analysis) for the respective campaign. Interface 1300 may also include an affordance 1308 enabling a user to start all jobs associated with all campaigns (e.g., to analyze all collected signal data according to the methods described herein).

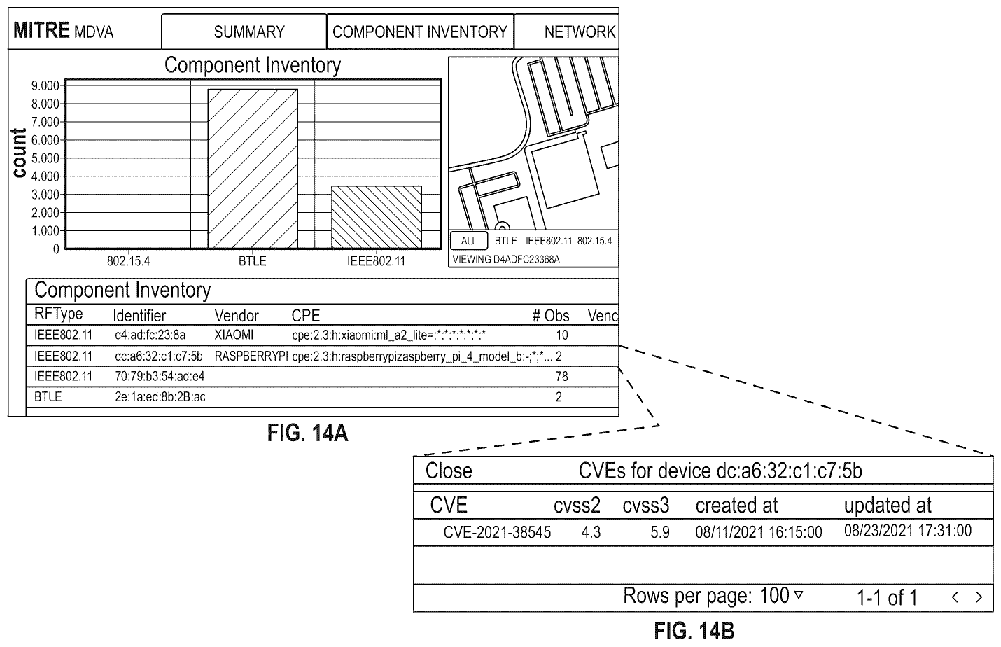

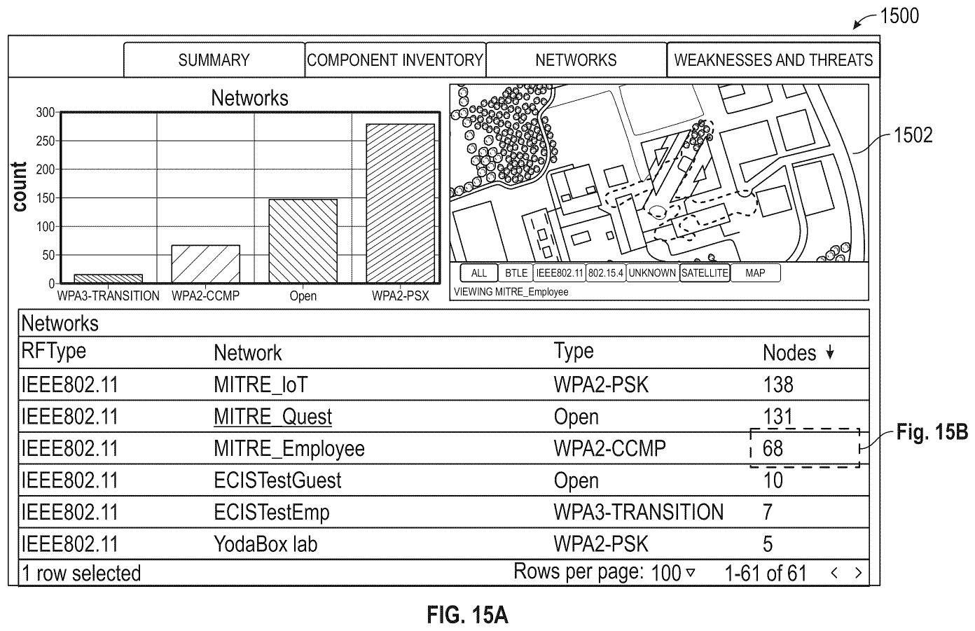

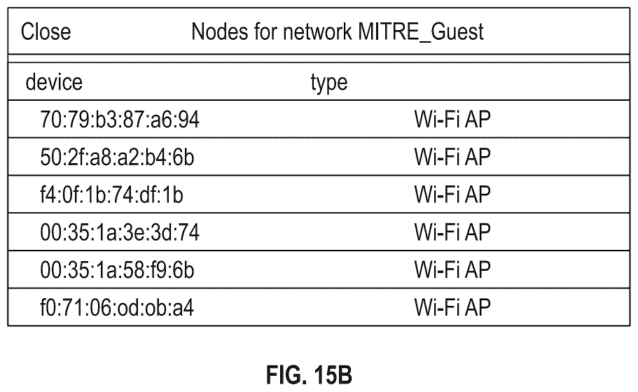

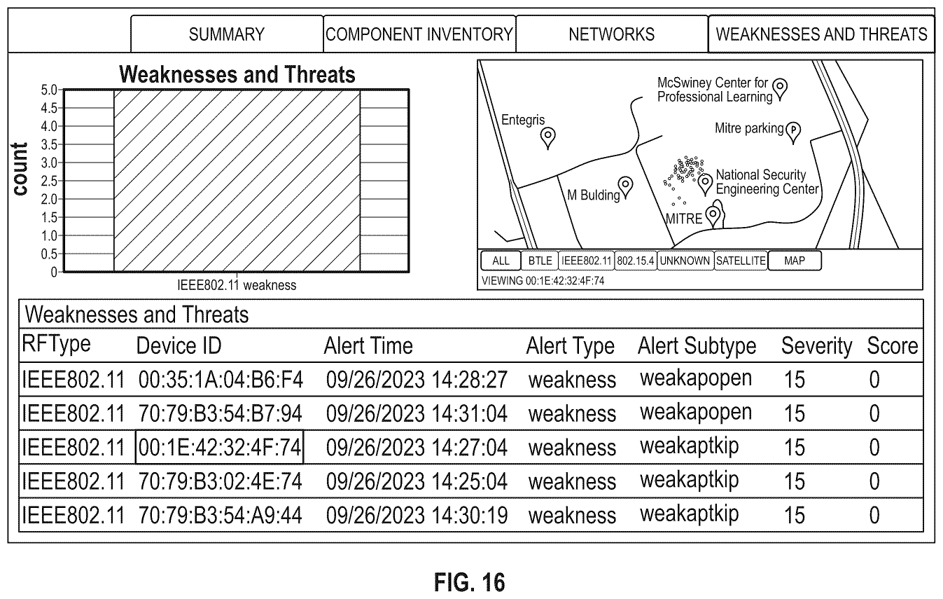

FIG. 14A illustrates aspects of an exemplary component inventory dashboard that may be used for or include one or more aspects of the component inventory dashboard 600. FIG. 14B shows a pop-up window displaying CVEs associated with a particular device shown in FIG. 14A. FIG. 15A illustrates aspects of an exemplary networks dashboard 1500 that may be used for or include one or more aspects of the networks dashboard 700 described above. Networks dashboard 1500 includes a heatmap 1502 that may be generated based on the wireless signal data described herein. The heat map implementation may be a kernel density estimation. The heat map 1502 may include a telemetry heat map that shows where the sensors described herein (e.g., the sensor kit) have been over time. The heat map 1502 may include an indication of the location at which each wireless signal observation occurred. The heat map 1502 may include a signal strength-based distribution of wireless observations based on the wireless signal data collected using the sensors. The heat map 1502 may include one or more layers associated with each wireless communication protocol (e.g., WiFi, Bluetooth, 802.15.4, etc.). The heat map may be interactive, enabling users to select one or more layers associated with the different wireless communication protocols for display. FIG. 15B illustrates a pop-up enabling a user to investigate the devices associated with a particular network. FIG. 16 illustrates aspects of an exemplary weaknesses and threats dashboard that may be used for or include one or more aspects of the weaknesses and threats dashboard 500 described above.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for determining device risk for a plurality of wireless devices based on one or more determined vulnerabilities, the method comprising:
receiving, by one or more processors, wireless signal data from a plurality of devices, wherein the received wireless signal data were detected by a plurality of wireless signal sensors;
classifying each of the plurality of devices based on the wireless signal data;
determining one or more vulnerabilities associated with each of the plurality of devices based on the classification of each of the plurality of devices;
determining at least one device risk for each of the plurality of devices based on the one or more device vulnerabilities.

2. The method of claim 1, comprising determining a risk to a facility based at least in part on the at least one device risk.

3. The method of claim 1, comprising: displaying an indication of the at least one device risk.

4. The method of claim 1, comprising: generating a recommended mitigation for at least one of the one or more vulnerabilities.

5. The method of claim 4, comprising: executing the recommended mitigation for at least one of the one or more vulnerabilities, wherein the recommended mitigation comprises any one or more of: patching a device, blocking a transmission from a device, deactivating a device, reconfiguring a device, segmenting off a portion of a network, and isolating a portion of a network.

6. The method of claim 1, comprising: determining at least one of a weakness associated with one or more devices of the plurality of devices and a threat associated with one or more devices of the plurality of devices.

7. The method of claim 6, comprising: generating a recommended mitigation for the weakness or the threat.

8. The method of claim 7, comprising: executing the recommended mitigation, wherein the recommended mitigation comprises any one or more of: patching a device, blocking a transmission from a device, deactivating a device, reconfiguring a device, segmenting off a portion of a network, and isolating a portion of a network.

9. The method of claim 6, wherein the weakness comprises any one or more of: an unencrypted wireless access point, a hidden access point, a rogue access point, a rogue hotspot access point, one or more inconsistent access point vendors, an Evil Twin access point, an unencrypted ad-hoc network, an unauthorized ad-hoc network, an always-discoverable device, an unencrypted communication, a weakly-encrypted communication, a use of compromised encryption keys, a use of vendor default encryption keys, and a 2G base station.

10. The method of claim 6, wherein the threat comprises any one or more of a spoofed device, an Evil Twin access point, and a 2G base station.

11. The method of claim 1, wherein each of the plurality of wireless signal sensors is configured to detect wireless signals of a respective wireless signal protocol of a plurality of wireless signal protocols.

12. The method of claim 1, wherein the plurality of devices are classified using at least one of: one or more passive inference techniques and one or more active interrogation techniques.

13. The method of claim 12, wherein the one or more passive inference techniques comprise any one or more of: a Wi-Fi probe-request frame taxonomy, a Wi-Fi beacon frame taxonomy, a Wi-Fi protected setup taxonomy, a passive Bluetooth taxonomy, OUI vendor matching, WPS vendor matching, WPS product matching, and Bluetooth Low Energy Generic Attribute Profile Blueprinting.

14. The method of claim 12, wherein the one or more active interrogation techniques comprise any one or more of: active Bluetooth interrogation, active Z-Wave interrogation, and active 802.15.4 interrogation.

15. The method of claim 1, wherein classifying the plurality of devices comprises determining any one or more of a vendor name, a product name, or a device code.

16. The method of claim 15, wherein the device code is a common platform enumerator (CPE), and wherein determining the one or more device vulnerabilities comprises determining a device vulnerability identifier based on the device code, wherein the device vulnerability identifier comprises a common vulnerability and exposure (CVE) number.

17. The method of claim 1, wherein classifying the plurality of devices comprises: generating a string based on the wireless signal data; hashing the string to generate a signature associated with a device of the plurality of devices; and classifying a respective device of the plurality of devices based on the signature.

18. The method of claim 1, wherein classifying the plurality of devices comprises: determining a device vendor based on a MAC address associated with the plurality of wireless signals.

19. The method of claim 1, wherein at least one of the plurality of devices is classified based on a combination of a plurality of classification techniques.

20. The method of claim 1, wherein determining the plurality of device risks for the plurality of devices based on the one or more device vulnerabilities comprises comparing the one or more device vulnerabilities to a list of predetermined device risks associated with the one or more device vulnerabilities.

21. The method of claim 1, comprising: determining a number of devices associated with one or more wireless communication protocols based on the wireless signal data.

22. The method of claim 21, further comprising: displaying a graphical user interface comprising a plurality of dashboards, wherein a first dashboard comprises an indication of the number of devices associated at least one of the one or more wireless protocols.

23. The method of claim 22, wherein the first dashboard comprises a user configurable geospatial view, wherein the geospatial view depicts an indication of a location of the plurality of devices.

24. The method of claim 22, wherein the first dashboard comprises an indication of one or more of vendors associated with the plurality of devices.

25. The method of claim 22, wherein a second dashboard comprises a list of the plurality of devices, wherein the list comprises a device identifier associated with a device of the plurality of devices, a wireless protocol associated with the device, a vendor associated with the device, and the device risk associated with the device.

26. The method of claim 22, wherein a third dashboard comprises an indication of one or more weaknesses and one or more threats associated with the one or more wireless devices.

27. The method of claim 1, further comprising: determining a relationship between a first device and a second device of the plurality of devices based on a communication between the first device and the second device.

28. The method of claim 27, comprising: generating a network map comprising a first node associated with the first device and a second node associated with the second device, wherein the network map depicts the relationship between the first device and the second device based on the communication between the first device and the second device.

29. The method of claim 1, comprising: determining one or more device subcomponents associated with a device of the plurality of devices based on the wireless signal data.

30. The method of claim 26, comprising: determining one or more subcomponent vulnerabilities associated with a device subcomponent of the one or more device subcomponents.

31. A non-transitory computer readable storage medium storing instructions for determining device risk for a plurality of wireless devices based on one or more detected vulnerabilities, the instructions configured to be executed by a system, the system comprising one or more processors to cause the system to:
receive, by the one or more processors, wireless signal data from a plurality of devices, wherein the received wireless signal data were detected by a plurality of wireless signal detectors;
classify the plurality of devices based on the wireless signal data;
determine one or more vulnerabilities associated with each of the plurality of devices based on the classification of each of the plurality of devices;
determine at least one device risk for each of the plurality of devices based on the one or more device vulnerabilities.

32. A system for determining device risk for a plurality of wireless devices based on one or more detected vulnerabilities, the system comprising:
one or more processors storing one or more computer programs that include computer instructions, which when executed by the one or more processors, cause the system to:
receive, by the one or more processors, wireless signal data from a plurality of devices wherein the received wireless signal data were detected by a plurality of wireless signal detectors;
classify the plurality of devices based on the wireless signal data;
determine one or more vulnerabilities associated with each of the plurality of devices based on the classification of each of the plurality of devices;
determine at least one device risk for each of the plurality of devices based on the one or more device vulnerabilities.

33. A system for determining device risk for a plurality of wireless devices based on one or more detected vulnerabilities, the system comprising:
a plurality of wireless signal detectors, wherein each of the wireless signal detectors is configured to detect wireless signals of a respective wireless signal protocol of a plurality of wireless signal protocols,
one or more processors storing one or more computer programs that include computer instructions, which when executed by the one or more processors, cause the system to:
receive, by the one or more processors, wireless signal data from a plurality of devices, wherein the received wireless signal data were detected by the plurality of wireless signal detectors;
classify the plurality of devices based on the wireless signal data;
determine one or more vulnerabilities associated with each of the plurality of devices based on the classification of each of the plurality of devices;
determine at least one device risk for each of the plurality of devices based on the one or more device vulnerabilities.
